(19) United States
(12) Patent Application Publication
(10) Pub. No.: US 2020/0058044 A1
(43) Pub. Date: Feb. 20, 2020

(54) SYSTEMS AND METHODS FOR CARPOOLING

(71) Applicant: BEIJING DIDI INFINITY TECHNOLOGY AND DEVELOPMENT CO., LTD., Beijing (CN)

(72) Inventors: Xiaolin DENG, Beijing (CN); Zhangxun LIU, Beijing (CN); Qi XIAO, Beijing (CN); Tihui ZHANG, Beijing (CN); Yang LIU, Beijing (CN)

(73) Assignee: BEIJING DIDI INFINITY TECHNOLOGY AND DEVELOPMENT CO., LTD., Beijing (CN)

(21) Appl. No.: 16/585,014

(22) Filed: Sep. 27, 2019

Related U.S. Application Data
(63) Continuation of application No. PCT/CN2017/118382, filed on Dec. 25, 2017.

(30) Foreign Application Priority Data
Mar. 27, 2017 (CN) 201710188427.2
Apr. 18, 2017 (CN) 201710253616.3
Apr. 18, 2017 (CN) 201710254157.0
Apr. 18, 2017 (CN) 201710254525.1
Apr. 18, 2017 (CN) 201710254547.8

(51) Int. Cl. G06Q 30/02; G06Q 10/02; G06Q 50/30; H04W 4/40

(52) U.S. Cl. CPC G06Q 30/0207; H04W 4/40; G06Q 50/30; G06Q 10/02

(57) ABSTRACT

The present disclosure relates to systems and methods for carpooling. The systems may perform the methods to receive an order from a passenger for a target transportation service from a terminal device, wherein the order includes a starting location and a destination of the target transportation service; determine a waiting time period related to the order; determine a discount based on the waiting time period; determine a target price of the order based on the starting location, the destination, and the discount; and send the target price to the terminal device.

### CROSS-REFERENCE TO RELATED APPLICATIONS

This application is a continuation of International Application No. PCT/CN2017/118382, filed on Dec. 25, 2017, which claims priority of Chinese Patent Application No. 201710188427.2 filed on Mar. 27, 2017, Chinese Patent Application No. 201710253616.3 filed on Apr. 18, 2017, Chinese Patent Application No. 201710254157.0 filed on Apr. 18, 2017, Chinese Patent Application No. 201710254525.1 filed on Apr. 18, 2017, and Chinese Patent Application No. 201710254547.8 filed on Apr. 18, 2017, the entire contents of each of which are hereby incorporated by reference.

### TECHNICAL FIELD

The present disclosure relates generally to systems and methods for on-demand service, and in particular, systems and methods for carpooling.

### BACKGROUND

On-demand transportation service, such as taxi services, has become more and more popular. Travel costs for private transportation are higher than public transportation, but public transportation is not convenient enough. Thus it is necessary to provide systems and methods for carpooling to reduce travel costs and improve travel flexibility.

### SUMMARY

According to a first aspect of the present disclosure, a system is provided. The system may include at least one storage medium and at least one processor in communication with the at least one storage medium. The at least one storage medium may include a set of instructions. When the at least one processor executes the set of instructions, the at least one processor may be directed to perform one or more of the following operations. The at least one processor may receive an order from a passenger for a target transportation service from a terminal device. The order may include a starting location and a destination of the target transportation service. The at least one processor may determine a waiting time period related to the order. The at least one processor may determine a discount based on the waiting time period. The at least one processor may determine a target price of the order based on the starting location, the destination, and the discount. The at least one processor may send the target price to the terminal device.

According to a second aspect of the present disclosure, a method for carpooling is provided. The method may be implemented on at least one computing device. Each of the at least one computing device may have at least one processor and storage. The method may include one or more of the following operations. The at least one processor may receive an order from a passenger for a target transportation service from a terminal device. The order may include a starting location and a destination of the target transportation service. The at least one processor may determine a waiting time period related to the order. The at least one processor may determine a discount based on the waiting time period. The at least one processor may determine a target price of the order based on the starting location, the destination, and the discount. The at least one processor may send the target price to the terminal device.

According to a third aspect of the present disclosure, a non-transitory computer readable medium is provided. The non-transitory computer readable medium may include a set of instructions. When the set of instructions are executed by at least one processor, the set of instructions may direct the at least one processor to perform one or more of the following operations. The at least one processor may receive an order from a passenger for a target transportation service from a terminal device. The order may include a starting location and a destination of the target transportation service. The at least one processor may determine a waiting time period related to the order. The at least one processor may determine a discount based on the waiting time period. The at least one processor may determine a target price of the order based on the starting location, the destination, and the discount. The at least one processor may send the target price to the terminal device.

In some embodiments, the order may be a carpooling order to share at least part of the target transportation service with another passenger.

In some embodiments, the at least one processor may obtain driving routes of a plurality of drivers. The at least one processor may determine a first matching condition related to the starting location, the destination of the target transportation service, and the driving routes. The at least one processor may determine a target driver from the plurality of drivers based on the first matching condition. The at least one processor may send the order to the target driver.

In some embodiments, the first matching condition may include at least one of a first overlapping degree, a first proximity degree, or a first detour degree.

In some embodiments, the at least one processor may receive a discount determination indication related to the order. The at least one processor may receive a first time point when receiving the order, and a second time point when receiving the discount determination indication. The at least one processor may determine the waiting time period based on the first time point and the second time point.

In some embodiments, the discount determination indication may include at least one of a stop waiting indication, a time over indication, or an order matching indication.

In some embodiments, the at least one processor may determine whether the discount determination indication includes a time over indication or a stop waiting indication. In response to the determination that the discount determination indication includes a time over indication or a stop waiting indication, the at least one processor may determine the target driver based on a second matching condition. The second matching condition may include at least one of a second overlapping degree, a second proximity degree, or a second detour degree.

In some embodiments, the at least one processor may receive a corresponding relationship between waiting time periods and discounts. The at least one processor may determine the discount based on the corresponding relationship between waiting time periods and discounts.

In some embodiments, the corresponding relationship between waiting time periods and discounts may include a linear relationship.

In some embodiments, the at least one processor may determine an original price for the target transportation service based on the starting location and the destination. The at least one processor may determine the target price of the order based on the original price and the discount.

According to a fourth aspect of the present disclosure, a system is provided. The system may include at least one storage medium and at least one processor in communication with the at least one storage medium. The at least one storage medium may include a set of instructions. When the set of instructions are executed, the at least one processor may be directed to perform one or more of the following operations. The at least one processor may receive first order data of one or more first orders. The first order data of a first order from the one or more first orders may include an order status and a plurality of features of the first order. The at least one processor may determine a plurality of weights corresponding to the plurality of features based on the first order data of the one or more first orders. The at least one processor may receive second order data of one or more second orders associated with a target transportation service from one or more users. The second order data of a second order from the one or more second orders may include at least one feature of the one or more first orders. The at least one processor may determine an estimated success rate of the second order from the one or more second orders to share the target transportation service with another user based on the at least one feature of the first order and the weight corresponding to the at least one feature.

According to a fifth aspect of the present disclosure, a method for carpooling is provided. The method may be implemented on at least one computing device. Each of the at least one computing device may have at least one processor and storage. The method may include one or more of the following operations. The at least one processor may receive first order data of one or more first orders. The first order data of a first order from the one or more first orders may include an order status and a plurality of features of the first order. The at least one processor may determine a plurality of weights corresponding to the plurality of features based on the first order data of the one or more first orders. The at least one processor may receive second order data of one or more second orders associated with a target transportation service from one or more users. The second order data of a second order from the one or more second orders may include at least one feature of the one or more first orders. The at least one processor may determine an estimated success rate of the second order from the one or more second orders to share the target transportation service with another user based on the at least one feature of the first order and the weight corresponding to the at least one feature.

According to a sixth aspect of the present disclosure, a non-transitory computer readable medium is provided. The non-transitory computer readable medium may include a set of instructions. When the set of instructions are executed by at least one processor, the set of instructions may direct the at least one processor to perform one or more of the following operations. The at least one processor may receive first order data of one or more first orders. The first order data of a first order from the one or more first orders may include an order status and a plurality of features of the first order. The at least one processor may determine a plurality of weights corresponding to the plurality of features based on the first order data of the one or more first orders. The at least one processor may receive second order data of one or more second orders associated with a target transportation service from one or more users. The second order data of a second order from the one or more second orders may include at least one feature of the one or more first orders. The at least one processor may determine an estimated success rate of the second order from the one or more second orders to share the target transportation service with another user based on the at least one feature of the first order and the weight corresponding to the at least one feature.

In some embodiments, the one or more first orders may be historical carpooling orders or vanpooling orders, and the second order may be a current carpooling order or vanpooling order.

In some embodiments, the order status of the first order from the one or more first orders may include a success status or a failure status.

In some embodiments, the weight corresponding to each feature of the one or more first orders may be determined according to a logistic regression model, a support vector machine algorithm, or a gradient boosting decision tree algorithm.

In some embodiments, the plurality of features of each first order may include at least one of a distance between a location of a driver and a pick-up location of a passenger, a distance between a destination of a driver and a destination of a passenger, a number of drivers around a passenger; or a time difference between an estimated time point when a driver arrives at a pick-up location of a passenger and a boarding time of a passenger.

In some embodiments, the at least one processor may determine a discount of the second order based on the estimated success rate.

In some embodiments, the at least one processor may determine a first discount coefficient and a second discount coefficient. The first discount coefficient may relate to a success status, and the second discount coefficient may relate to a failure status. The at least one processor may determine the discount of the second order based on the estimated success rate, the first discount coefficient, and the second discount coefficient.

In some embodiments, the first discount coefficient may be smaller than the second discount coefficient.

In some embodiments, the at least one processor may adjust the first discount coefficient or the second discount coefficient based on the discount and the estimated success rate of the second order.

In some embodiments, the at least one processor may receive one or more user features of a passenger related to the second order. The at least one processor may determine an estimated discount based on the estimated success rate of the second order. The at least one processor may determine a first willing-to-carpool success rate based on the estimated discount and the one or more user features. The at least one processor may determine a first target success rate based on the estimated success rate and the first willing-to-carpool success rate. The at least one processor may determine a discount based on the first target success rate, a second target success rate, and the estimated discount. The second target success rate may be determined based on a second willing-to-carpool success rate and the estimated success rate, and the second willing-to-carpool success rate may be determined based on the discount and the one or more user features.

In some embodiments, the at least one processor may determine whether the passenger is a first-time user based on the one or more user features. In response to a determination that the passenger is not a first-time user, the at least one processor may determine the discount based on a first constraint function and a first target function. The first constraint function may represent that a difference between the second target success rate and the first target success rate is smaller than a first value, and the first target function may represent a maximum difference between the discount and the estimated discount. In response to a determination that the passenger is a first-time user, the at least one processor may determine the discount based on a second constraint function and a second target function. The second constraint function may represent that a difference between the discount and the estimated discount is smaller than a second value, and the second target function may represent a maximum difference between the second target success rate and the first target success rate.

In some embodiments, the estimated discount may have a positive correlation to the estimated success rate.

In some embodiments, the at least one processor may select a third order from the one or more second orders. The estimated success rate of the third order may be larger than a third value. The at least one processor may receive order data of the third order. The order data of the third order includes a location, a destination, a boarding time of a passenger, and an order transmission time of the third order. The at least one processor may determine one or more first drivers based on the order data of the third order.

In some embodiments, each of the one or more first drivers may correspond to a first driving route, first pick-up locations, first drop-off locations, and a first departure time.

In some embodiments, the at least one processor may send the third order to at least one of the one or more first drivers. The at least one processor may send the first driving route, first pick-up locations, first drop-off locations, and first departure time to the passenger.

In some embodiments, the at least one processor may determine one or more first candidate drivers based on first driving routes of the one or more first drivers and the third order. A distance between the location of the passenger of the third order and at least one location on the driving routes of the one or more first candidate drivers may be in a predetermined distance range. The at least one processor may determine one or more arriving time periods that the passenger of the third order arrives pick-up locations of the one or more first candidate drivers based on a location of the passenger. The at least one processor may determine one or more arriving time points that the passenger of the third order arrives at the pick-up locations of the one or more first candidate drivers based on the arriving time periods and the order transmission time of the third order. The at least one processor may determine whether the arriving time point is before the first departure time of the first candidate driver. In response to the arriving time point is before the first departure time of the first candidate driver, the at least one processor may determine the first candidate driver as a second candidate driver.

In some embodiments, the at least one processor may determine whether the number of the second candidate driver is larger than one. In response to the number of the one or more second candidate drivers is larger than one, the at least one processor may select a second candidate driver from the one or more second candidate drivers to be the first driver based on a distance between a first pick-up location of the second candidate driver and the location of the passenger of the third order. In response to the number of the second candidate driver is one, the at least one processor may determine the second candidate driver as the first driver.

In some embodiments, the at least one processor may determine whether there is a first driver. In response to there is no first driver, the at least one processor may assign the third order to a second driver based on the location of the passenger of the third order. The at least one processor may determine a second driving route, a second pick-up location, a second drop-off location, and a second departure time of the second driver based on the location, the destination, and boarding time of the passenger of the third order.

In some embodiments, the at least one processor may receive a conventional route, conventional pick-up locations, and conventional drop-off locations. The at least one processor may determine the second driving route of the second driver based on the destination of the third order and the conventional route. The at least one processor may determine the second pick-up locations and the second drop-off locations of the second driver based on the location of the passenger of the third order, a location of the second driver, the conventional pick-up locations, and the conventional drop-off locations. The at least one processor may determine the second departure time of the second driver based on the boarding time of the passenger of the third order.

In some embodiments, the at least one processor may send the second pick-up location, the second drop-off location, the second driving route, and the second departure time of the second driver to the passenger of the third order and the second driver.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-demand service system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a flowchart illustrating an exemplary process for determining a discount of a carpooling order according to some embodiments of the present disclosure;

FIG. 5 is a flowchart illustrating an exemplary process for determining a discount of a carpooling order according to some embodiments of the present disclosure;

FIG. 6 is a block diagram illustrating an exemplary discount determination device according to some embodiments of the present disclosure;

FIG. 7 is a flowchart illustrating an exemplary process for determining an estimated carpooling success rate of a carpooling order according to some embodiments of the present disclosure;

FIG. 8 is a flowchart illustrating an exemplary process for processing a carpooling order according to some embodiments of the present disclosure;

FIG. 9 is a block diagram illustrating an exemplary carpooling order processing device according to some embodiments of the present disclosure;

FIG. 10 is a block diagram illustrating an exemplary carpooling order processing device according to some embodiments of the present disclosure;

FIG. 11 is a flowchart illustrating an exemplary process for determining a discount of a carpooling order according to some embodiments of the present disclosure;

FIG. 12 is a block diagram illustrating an exemplary carpooling discount determination device according to some embodiments of the present disclosure;

FIG. 13 is a flowchart illustrating an exemplary process for determining a discount of a carpooling order according to some embodiments of the present disclosure;

FIG. 14 is a flowchart illustrating exemplary process for determining a discount of a carpooling order according to some embodiments of the present disclosure;

FIG. 15 is a block diagram illustrating an exemplary carpooling discount determination device according to some embodiments of the present disclosure;

FIG. 16 is a block diagram illustrating an exemplary carpooling discount determination device according to some embodiments of the present disclosure;

FIG. 17A is a flowchart illustrating an exemplary process for determining a first driver according to some embodiments of the present disclosure;

FIG. 17B is a flowchart illustrating an exemplary process for determining a first driver according to some embodiments of the present disclosure;

FIG. 17C a flowchart illustrating an exemplary process for determining a second driver according to some embodiments of the present disclosure;

FIG. 18A is a flowchart illustrating an exemplary process for determining a driver for a target order according to some embodiments of the present disclosure;

FIG. 18B is a flowchart illustrating an exemplary process for determining a driver for a target order according to some embodiments of the present disclosure; and

FIG. 19 a block diagram illustrating an exemplary carpooling device according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of the present disclosure. It is to be expressly understood, however, that the drawings are for purposes of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

The term “carpooling” in the present disclosure refers to a sharing of journeys so that more than one person travels in a car. In the present disclosure, the carpooling service may refer to a service that more than one passengers request for sharing journeys and call for a vehicle. The carpooling service may also refer to a service that a driver wants to share his/her vehicle with at least one passenger during the journey. The carpooling service may be a one-off.

The terms “passenger,” “requestor,” “service requestor,” and “user” in the present disclosure are used interchangeably to refer to an individual, an entity, a package, or a tool that may be involved in a transportation service. Also, the term “driver,” “provider,” and “service provider” in the present disclosure are used interchangeably to refer to an individual, an entity, or a tool that may provide a service or facilitate the providing of the service.

The terms “service request,” “order,”, “carpooling order” and “vanpooling order” in the present disclosure are used interchangeably to refer to a request that may be initiated by a passenger, a service requestor, a user, or the like, or any combination thereof. The service request may be accepted by any one of a driver, a provider, or a service provider. The service request may be chargeable or free.

The term “driver device” in the present disclosure is used to refer to a mobile terminal that is used by a service provider to provide a service or facilitate the providing of the service. The term “terminal” in the present disclosure is used to refer to a mobile terminal that is used by a service requestor to request or order a service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure is directed to systems and methods for determining a discount for a carpooling order of a user. According to the present disclosure, the systems and methods may determine a waiting time period of the user and determine the discount based on the waiting time period. The systems and methods may also determine a target price of the carpooling order based on the discount. During a timing process of the waiting time period, the systems and methods may prompt the user that the longer the user waits, the lower the target price of the carpooling order will be.

Another aspect of the present disclosure is directed to systems and methods for determining an estimated carpooling success rate of a carpooling order. According to the present disclosure, the systems and methods may determine the estimated carpooling success rate based on carpooling features of the carpooling order and weights corresponding to the carpooling features of the carpooling order. The systems and methods may determine the weights based on one or more historical orders acquired in a predetermined time period. The systems and methods may also determine a discount based on the estimated carpooling success rate of the carpooling order according to different calculation equations. The systems and methods may also dispatch a driver for a carpooling order with the estimated carpooling success rate of which is larger than a predetermined threshold. The driver may be a first driver with predetermined driving parameters have been determined or a second driver whose driving parameters have not been determined.

It should be noted that the online on-demand transportation service, such as online taxi hailing, is a new form of service rooted only in post-Internet era. It provides technical solutions to users and service providers that could raise only in post-Internet era. In pre-Internet era, when a user hails a taxi on street, the taxi request and acceptance occur only between the passenger and one taxi driver that sees the passenger. If the passenger hails a taxi through telephone call, the service request and acceptance may occur only between the passenger and one service provider (e.g., one taxi company or agent). Online taxi, however, allows a user of the service to real-time and automatic distribute a service request to a vast number of individual service providers (e.g., taxi) distance away from the user. It also allows a plurality of service provides to respond to the service request simultaneously and in real-time. Therefore, through Internet, the online on-demand transportation systems may provide a much more efficient transaction platform for the users and the service providers that may never met in a traditional pre-Internet transportation service system. Carpooling, which is a special kind of online on-demand transportation service, provides a secure and efficient service for both passengers and drivers.

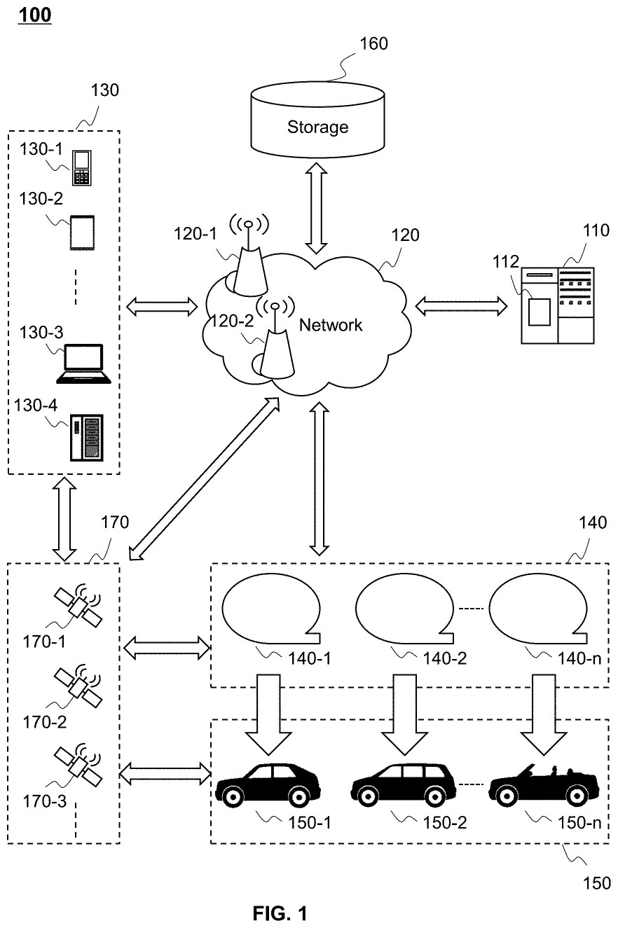

FIG. 1 is a schematic diagram illustrating an exemplary on-demand service system 100 according to some embodiments of the present disclosure. The on-demand service system 100 may be an online transportation service platform implemented in a network environment with a positioning system for providing transportation services. The on-demand service system 100 may include a server 110, a network 120, a terminal device 130, a driver device 140, a vehicle 150, a storage 160, and a positioning device 170.

The on-demand service system 100 may provide a plurality of services. Exemplary on-demand service may include a carpool service, a vanpool service, a taxi hailing service, a chauffeur service, an express car service, a bus service, a driver hire service, and a shuttle service. In some embodiments, an on-demand service may be provided with supplementary information recommended to perform the on-demand service. The order types may include a taxi order, a luxury car order, an express car order, a bus order, a shuttle order, etc. In some embodiments, the service may be any on-line service, such as booking a meal, shopping, or the like, or a combination thereof.

The server 110 may be a computer server. The server 110 may communicate with the terminal device 130 and/or the driver device 140 to provide various functionality of an online on-demand service. In some embodiments, the server 110 may be a single server, or a server group. The server group may be a centralized server group connected to the network 120 via an access point, or a distributed server group connected to the network 120 via one or more access points, respectively. In some embodiments, the server 110 may be locally connected to the network 120 or in remote connection with the network 120. For example, the server 110 may access information and/or data stored in the terminal device 130, the driver device 140, and/or the storage 160 via the network 120. As another example, the storage 160 may serve as backend storage of the server 110. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the server 110 may include a processing engine 112. The processing engine 112 may process information and/or data related to performing one or more functions described in the present disclosure. For example, the processing engine 112 may receive a carpooling order from a terminal device 130. For example, the processing engine 112 may determine a discount associated with the carpooling order. As another example, the processing engine 112 may determine a driver for the carpooling order. In some embodiments, the processing engine 112 may include one or more processing units (e.g., single-core processing engine(s) or multi-core processing engine(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the terminal device 130, the driver device 140, the vehicle 150, the storage 160) may send information and/or data to other component(s) in the on-demand service system 100 via the network 120. For example, the server 110 may access and/or obtain a plurality of historical orders from the storage 160 via the network 120. For example, the server 110 may transmit a pick-up location of a driver to the terminal device 130. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a passenger or a user may be a holder of the terminal device 130. In some embodiments, the holder of the terminal device 130 may be someone other than the passenger. For example, a holder A of the terminal device 130 may use the terminal device 130 to send a service request for a passenger B, and/or receive a service confirmation and/or information or instructions from the server 110. In some embodiments, a driver may be a user of the driver device 140. In some embodiments, the user of the driver device 140 may be someone other than the driver. For example, a user C of the driver device 140 may use the driver device 140 to receive a service request for a driver D, and/or information or instructions from the server 110. In some embodiments, a driver may be assigned to use one of the driver device 140 and/or one of the vehicles 150 for at least a certain period of time, for example, a day, a week, a month, or a year etc. In some other embodiments, a driver may be assigned to use one of the driver device 140 and/or one of the vehicles 150 on a random basis. For example, when a driver is available to provide an on-demand service, he/she may be assigned to use a driver terminal that receives the earliest request and a vehicle that is recommended to perform the type of on-demand service. In some embodiments, “passenger” and “terminal device” may be used interchangeably, and “driver” and “driver device” may be used interchangeably. In some embodiments, the driver device may be associated with one or more drivers (e.g., a night-shift driver, a day-shift driver, or a driver pool by a random shifting).

In some embodiments, the terminal device 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include a built-in computer, an onboard built-in television, a built-in tablet, etc. In some embodiments, the terminal device 130 may include a signal transmitter and a signal receiver configured to communicate with the positioning device 170 for locating the position of the passenger and/or the terminal device 130.

The driver device 140 may include a plurality of driver devices 140-1, 140-2, . . . , 140-n. In some embodiments, the driver device 140 may be similar to, or the same device as the terminal device 130. In some embodiments, the driver device 140 may be customized to implement the online transportation service. In some embodiments, the driver device 140 and the terminal device 130 may be configured with a signal transmitter and a signal receiver to receive position information of the driver device 140 and the terminal device 130 from the positioning device 170. In some embodiments, the terminal device 130 and/or the driver device 140 may communicate with other positioning device to determine the position of the passenger, the terminal device 130, the driver, and/or the driver device 140. In some embodiments, the terminal device 130 and/or the driver device 140 may periodically send the positioning information to the server 110. In some embodiments, the driver device 140 may also periodically send the availability status to the server 110. The availability status may indicate whether a vehicle 150 associated with the driver device 140 is available to transport a passenger. For example, the terminal device 130 may send the positioning information to the server 110 every thirty minutes. As another example, the driver device 140 may send the availability status to the server every thirty minutes, and/or upon an on-demand service is completed. As another example, the terminal device 130 may send the positioning information to the server 110 each time the user logs into the mobile application associated with the online on-demand service.

In some embodiments, the driver device 140 may correspond to one or more vehicles 150. The vehicles 150 may carry the passenger and travel to the destination. The vehicles 150 may include a plurality of vehicles 150-1, 150-2, . . . , 150-n. One of the plurality of vehicles may correspond to one order type. The order types may include a taxi order, a luxury car order, a limousine order, an express car order, a bus order, a shuttle order, etc.

The storage 160 may store data and/or instructions. In some embodiments, the storage 160 may store data obtained from the terminal device 130 and/or the driver device 140. For example, the storage 160 may store log information associated with the terminal device 130. In some embodiments, the storage 160 may store data and/or instructions that the server 110 may execute to provide the on-demand services described in the present disclosure. In some embodiments, the storage 160 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

The positioning device 170 may determine information associated with an object, for example, one or more of the terminal device 130, the driver device 140, the vehicle 150, etc. For example, the positioning device 170 may determine a current time and a location of a passenger or a driver through the terminal device 130. In some embodiments, the positioning device 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, and/or a current time. The location may be in the form of coordinates, such as, a latitude coordinate and a longitude coordinate, etc. The positioning device 170 may include one or more satellites, for example, a satellite 170-1, a satellite 170-2, and a satellite 170-3. The satellites 170-1 through 170-3 may determine the information mentioned above independently or jointly. The positioning system 170 may send the information mentioned above to the terminal device 130, the driver device 140, or the vehicle 150 via the network 120.

In some embodiments, one or more components in the on-demand service system 100 may access the data or instructions stored in the storage 160 via the network 120. In some embodiments, the storage 160 may be directly connected to the server 110 as a backend storage.

In some embodiments, one or more components in the on-demand service system 100 (e.g., the server 110, the terminal device 130, the driver device 140, etc.) may have permissions to access the storage 160. In some embodiments, one or more components in the on-demand service system 100 may read and/or modify the information related to the passenger, the driver, and/or the vehicle when one or more conditions are met. For example, the server 110 may read and/or modify one or more passengers' user features after an on-demand service order is completed.

In some embodiments, information exchanging between one or more components of the on-demand service system 100 may be initiated by way of launching the mobile application of the on-demand service on a terminal device to request a service. The object of the service request may be any product. In some embodiments, the product may include food, medicine, commodity, chemical product, electrical appliance, clothing, car, housing, luxury, or the like, or any combination thereof. In some other embodiments, the product may include a service product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element of the on-demand service system 100 performs, the element may perform through electrical signals and/or electromagnetic signals. For example, when a terminal device 130 processes a task, such as transmitting an order, the terminal device 130 may operate logic circuits in its processor to process such task. When the terminal device 130 sends out an order to the server 110, a processor of the terminal device 130 may generate electrical signals encoding the order. The processor of the terminal device 130 may then send the electrical signals to an output port. If the terminal device 130 communicates with the server 110 via a wired network, the output port may be physically connected to a cable, which further transmit the electrical signal to an input port of the server 110. If the terminal device 130 communicates with the server 110 via a wireless network, the output port of the terminal 130 may be one or more antennas, which convert the electrical signals to electromagnetic signals. Similarly, a driver device 140 may process a task through operation of logic circuits in its processor, and receive an instruction and/or service order from the server 110 via electrical signals or electromagnet signals. Within an electronic device, such as the terminal device 130, the driver device 140, and/or the server 110, when a processor thereof processes an instruction, sends out an instruction, and/or performs an action, the instruction and/or action is conducted via electrical signals. For example, when the processor retrieves data (e.g., a plurality of historical orders) from a storage medium (e.g., a storage 160), it may send out electrical signals to a read device of the storage medium, which may read structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

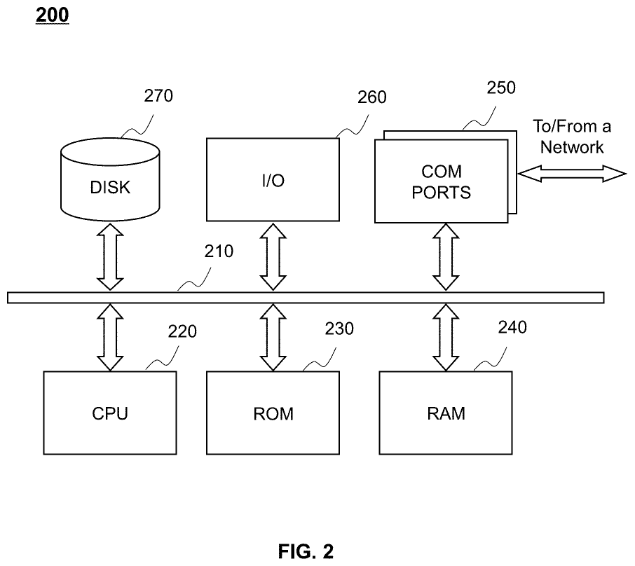

FIG. 2 is a schematic diagram illustrating exemplary hardware and/or software components of a computing device 200 according to some embodiments of the present disclosure.

The computing device 200 may be a general purpose computer or a special purpose computer. Both may be used to implement an on-demand system of the present disclosure. The computing device 200 may be used to implement any component of the service as described herein. For example, the processing engine 112 of the server may be implemented on the computing device 200, via its hardware, software program, firmware, or a combination thereof. Although only one such computer is shown for convenience, the computer functions related to the service as described herein may be implemented in a distributed manner on a number of similar platforms to distribute the processing load.

The computing device 200, for example, may include COM ports 250 connected to and from a network (e.g., the network 120) connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the CPU 220. The methods and/or processes of the present disclosure may be implemented as the program instructions. The computing device 200 also includes an I/O component 260, supporting input/output between the computer, the user, and other components therein. The computing device 200 may also receive programming and data via network communications.

Merely for illustration, only one CPU and/or processor is described in the computing device 200. However, it should be noted that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, the CPU and/or processor of the computing device 200 may execute both step A and step B. As in another example, step A and step B may also be performed by two different CPUs and/or processors jointly or separately in the computing device 200 (e.g., the first processor executes step A and the second processor executes step B, or the first and second processors jointly execute steps A and B).

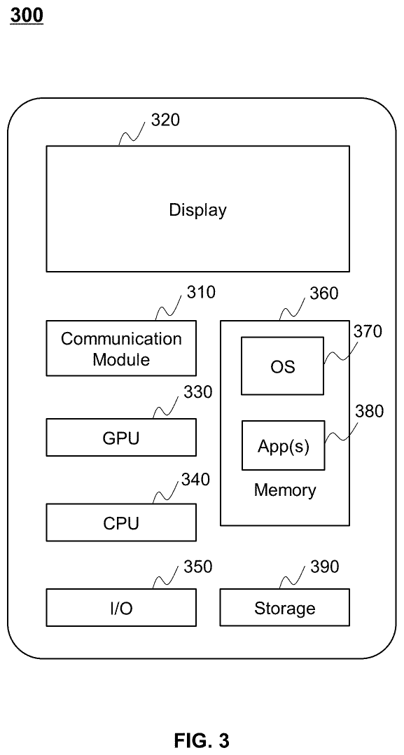

FIG. 3 is a schematic diagram illustrating exemplary hardware and/or software components of a mobile device 300 according to some embodiments of the present disclosure.

As illustrated in FIG. 3, the mobile device 300 may include a communication module 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for transmitting, receiving and presenting information relating to a service order (e.g., a plurality of POIs associated with a query) from the processing engine 112 and/or the storage 160. User interactions with the information stream may be achieved via the I/O 350 and provided to the processing engine 112 and/or other components of the on-demand service system 100 via the network 120.

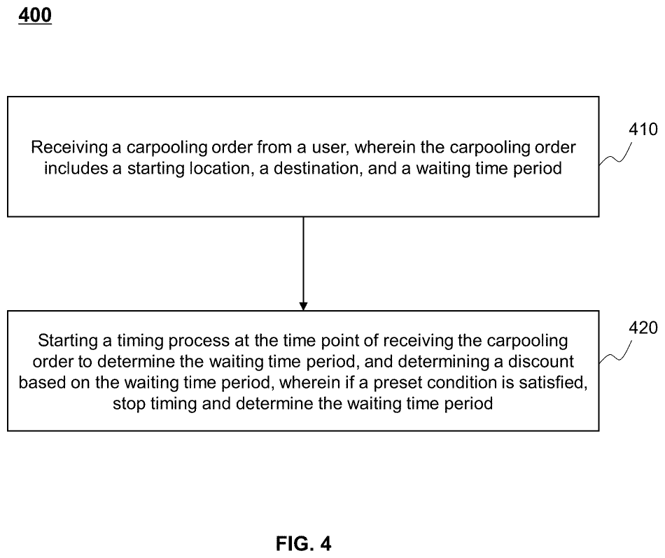

FIG. 4 is a flowchart illustrating an exemplary process 400 for determining a discount of a carpooling order according to some embodiments of the present disclosure. In some embodiments, the process 400 may be executed by the processing engine 120. For example, the process 400 may be implemented as a set of instructions (e.g., an application) stored in the storage 160. The server 110, the CPU 220 and/or the CPU 340 may execute the set of instructions and may accordingly be directed to perform the process 400.

In 410, the processing engine 120 may receive a carpooling order from a user for a target transportation service from a terminal device. A carpooling order may refer to an order that a user is willing to share at least part of the target transportation service with another passenger. The carpooling order may include a starting location, a destination and a waiting time period of the user. For example, a terminal device (e.g., the terminal device 130) of the user may receive input from the user relating to the carpooling order. The user terminal may transmit the carpooling order to the processing engine 112. The processing engine 112 may perform one or more operations to process the carpooling order such as determine a waiting time period of the user, assign a driver for the carpooling order, etc.

In 420, the processing engine 120 may start a timing process at the time of receiving the carpooling order to determine the waiting time period, and determine a discount based on the waiting time period. During the timing process, if a preset condition is satisfied, the processing engine 120 may stop timing and determine the waiting time period.

The waiting time period may be a time period during which a user may keep waiting for a suitable driver (e.g., a driver with a same starting location and a same destination as the user). In some embodiments, the waiting time period may start from a time point of receiving the carpooling order, and may end at a time point when a preset condition is satisfied. In some embodiments, the preset condition may relate to one or more discount determination indications. Merely for illustration purposes, the discount determination indications may include a time over indication, a stop waiting indication, or an order matching indication. The time over indication may refer to the waiting time period of a user has reached a preset maximum waiting time period (e.g., 10 minutes). The stop waiting indication may refer to a user instruction received through a terminal device indicating that the user is unwilling to wait. The order matching indication may indicate that the carpooling order is matched with a driver.

In some embodiments, the processing engine 112 may determine the preset maximum waiting time period based on historical data and the carpooling order. The historical data may include information related to one or more historical carpooling orders. The historical data may include, for example, starting locations, destinations, and average waiting time periods. When the waiting time period of a user reaches the preset maximum waiting time, the processing engine 120 may receive a time over indication, and stop timing.

In some embodiments, the processing engine 120 may receive a driving route from a driver (e.g., through the driver device 140). To match the carpooling order to the driver, the carpooling order and the driving route of the driver may satisfy a preset matching condition. The preset matching condition may include an overlapping degree, a proximity degree, a detour degree, etc. In some embodiments, the processing engine 112 may determine the preset matching condition based on the driving route of the driver, the starting location and/or the destination of the carpooling order.

Merely for illustration purposes, the processing engine 112 may set the overlapping degree to be 95%. If an overlapping degree between the driving route of the driver and a route between the starting location and the destination of a user is not less than 95%, the carpooling order may be matched to the driver. In some embodiments, the processing engine 112 may adjust the preset matching condition (e.g., at least one of the overlapping degree, the proximity degree, and the detour degree). For example, when the processing engine 120 receive a stop waiting indication (i.e., the user is not willing to wait) or a time over indication, the processing engine 112 may adjust the matching condition. Merely by way of example, the processing engine 112 may set the overlapping degree to 70%. The processing engine 112 may match the carpooling order of the user to a driver more easily.

The processing engine 120 may determine a discount of the carpooling order based on the waiting time period and a corresponding relationship between waiting periods and discounts. The discount may refer to a percentage value, for example, 80%, 0.9, etc. The processing engine 120 may determine a target price of a carpooling order by calculating a product of an original price of the carpooling order and the discount (i.e., a percentage value). As used herein, the original price may refer to the price of a carpooling order without any discount. The discount may relate a reduced price of the order, which may be a difference between an original price and the target price. In some embodiments, the corresponding relationship between waiting time periods and discounts may be a linear relationship, which indicates the value of the discount of a carpooling order may decrease when a user keep waiting. In some embodiments, the corresponding relationship between waiting time periods and discounts may include a directly proportional relationship, a reversely proportional relationship, a square relationship, an exponential relationship, a power exponential relationship, or the like, or a combination thereof.

In some embodiments, the processing engine 120 may determine the target price of the carpooling order based on the discount and an original price of the carpooling order. In some embodiments, the processing engine 112 may determine the original price of a carpooling order based on order information, such as the starting location, the destination, the time point of receiving the carpooling order, etc. For example, the original price of a carpooling order in the evening may be higher than that in the morning.

In some embodiments, by adjusting the discount, the processing engine 120 may control the waiting time period of a user for carpooling, prolong the life cycle of a carpooling order, provide more time window periods for matching a carpooling order, and achieve more carpooling orders and a lower detour ratio.

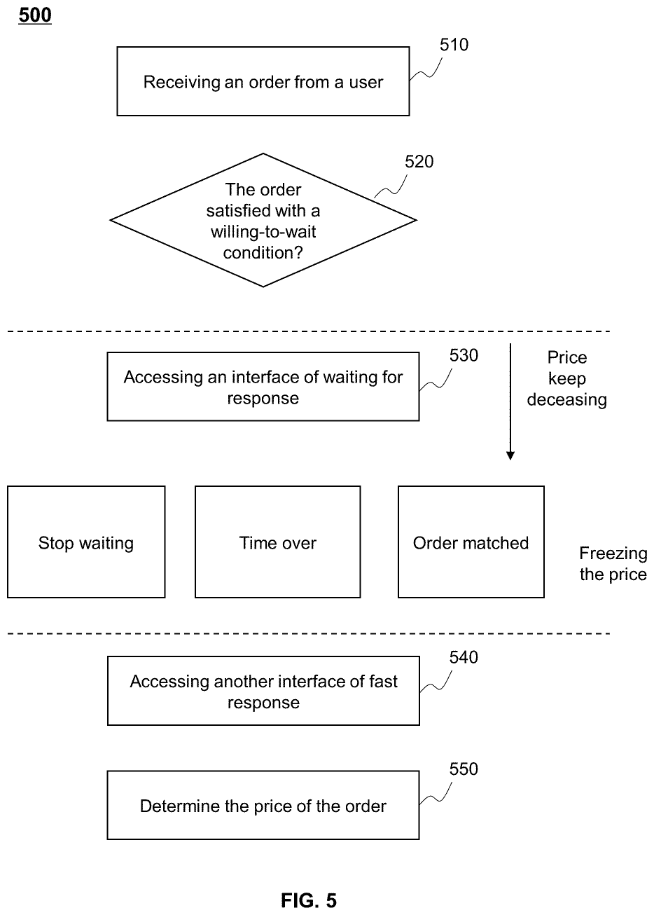

FIG. 5 is a flowchart illustrating an exemplary process 500 for determining a discount of a carpooling order according to some embodiments of the present disclosure. In some embodiments, the process 500 may be executed by the processing engine 120. For example, the process 500 may be implemented as a set of instructions (e.g., an application) stored in the storage 160. The server 110, the CPU 220 and/or the CPU 340 may execute the set of instructions and may accordingly be directed to perform the process 500.

In 510, the processing engine 120 may receive a carpooling order from a user. The carpooling order may include a starting location, a destination, a time point of receiving the order, etc.

In 520, the processing engine 112 may determine whether the order is satisfied with a willing-to-wait condition. The processing engine 112 may determine whether the carpooling order is satisfied with a willing-to-wait condition based on the starting location and the destination of the carpooling order. If the carpooling order is satisfied with the willing-to-wait condition, the on-demand service system 100 may proceed to 530 to initialize a willing-to-wait mode. In the willing-to-wait mode, the processing engine 112 may determine a waiting time period of the user.

In 530, the processing engine 112 may access an interface of waiting for response in the willing-to-wait mode. The interface of waiting for response may be displayed on a terminal device (e.g., the terminal device 130). The interface of waiting for response may remind the user that the longer the user waits, the lower the price of the carpooling order will be. For example, after receiving an order from a user, the interface of waiting for response may display a countdown prompt of a preset maximum waiting time (e.g., 7 minutes). In some embodiments, the processing engine 112 may set the preset maximum waiting time according to default settings of the on-demand service system 100. The countdown prompt may include a countdown progress bar which indicates the countdown process of the preset maximum waiting time. In some embodiments, a preset maximum discount may be averaged according to the preset maximum waiting time. Thus the price of the carpooling order may decrease linearly over time. In some embodiments, the on-demand service system 100 may determine the preset maximum discount based on the time point of receiving the order, the starting location, and the destination of the carpooling order, etc. The price may continuously keep decreased from an original price of the order by a preset granularity (e.g., ¥0.01). If a preset condition (e.g., the user stops waiting, the preset maximum waiting time is over, or the order is matched) is satisfied, the processing engine 112 may freeze the price and proceed to step 540.

In 540, the processing engine 112 may access another interface of fast response. In some embodiments, the interface of fast response may be displayed on a user terminal (e.g., the terminal device 130). The interface of fast response may display the frozen price and an indication of accelerating the process for dispatching a driver for the carpooling order. In some embodiments, the indication may be displayed in a form of a breathing bar.

In 550, the processing engine 112 may determine the target price of the carpooling order as the frozen price. The processing engine 112 may also transmit the target price of the carpooling order to the user terminal of the user.

In some embodiments, in the interface of waiting for response, the on-demand service system 100 may continuously search for a driver matched to the order under a matching condition (e.g., with an overlapping degree, a proximity degree, or a detour degree), a carpooling success rate, a carpooling ratio, etc. When the processing engine 112 matches the carpooling order to a driver, the processing engine 112 may freeze the target price at the moment when matching the carpooling order to the driver.

Merely for illustration purposes, when the user is not willing to wait any longer (e.g., the user clicks a “Stop Waiting” button on the interface of waiting for response), the willing-to-wait mode may terminate. The processing engine 112 may return to a normal response mode (e.g., the processing engine 112 accesses an interface of fast response), and the target price of the carpooling order may be frozen at the moment when the on-demand service system 100 receives a stop waiting indication. When the user clicks the “Stop Waiting” button or the on-demand service system 100 has found a driver matched to the order, the countdown of the preset maximum waiting time may end and the price displayed on the interface of waiting for response may be frozen immediately. In some embodiments, the countdown progress bar on the interface of waiting for response may turn into a breathing bar at the same time. The breathing bar may indicate that the waiting time period is over and the system is searching for vehicles/drivers for the carpooling order with another matching condition.

In some embodiments, when the waiting time period of a user has reached the preset maximum waiting time, the processing engine 112 may also freeze the price at the moment of reaching the maximum waiting time.

In some embodiments, if a passenger sends a carpooling order via his/her terminal device, and the carpooling order satisfies a willing-to-wait condition, the terminal device (e.g., the terminal device 130) of the user may display a price of the carpooling order, which may continuously decreasing in the waiting process of the user. The processing engine 112 may determine the target price of the carpooling order when a maximum waiting period is over (e.g., after a waiting time period of 5 minutes).

In some embodiments, if a passenger sends a carpooling order which satisfies a willing-to-wait condition, the on-demand service system 100 may make an immediate response when the passenger clicks the “Stop Waiting” button after a certain time period (e.g., 1 minute) for stop waiting, so as to ensure a good user experience.

In some embodiments, after the user clicks the “Stop Waiting” button on the interface of waiting for response, a new user interface for confirming an access to the interface of fast response may be displayed. An inquiry message showing “whether to access the interface of fast response” and the target price of the carpooling order may be displayed on the new user interface. The processing engine 112 may access the new interface of fast response according to a confirmation from the user.

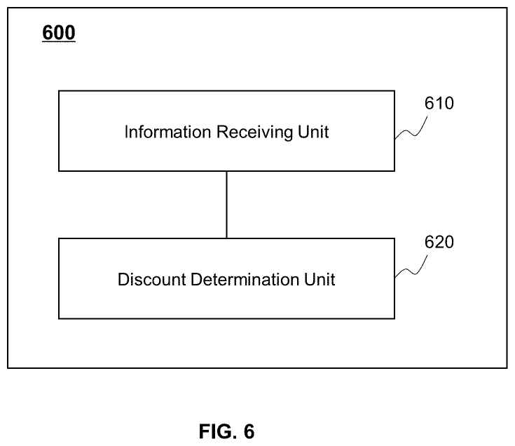

FIG. 6 is a block diagram illustrating an exemplary discount determination device 600 according to some embodiments of the present disclosure. The discount determination device 600 may include an information receiving unit 610, and a discount determination unit 620. In some embodiments, the discount determination device 600 may be configured to perform one or more operations in the process 400 and/or the process 500. In some embodiments, the discount determination device 600 may be implemented as the processing device 120.

The information receiving unit 610 may be configured to receive a carpooling order from a user. The carpooling order may include a starting location, a destination and a waiting time period of the user.

The discount determination unit 620 may be configured to start a timing process at the time of receiving the carpooling order to determine the waiting time period, and determine a discount based on the waiting time period. In the timing process, if a preset condition is satisfied, the discount determination unit 620 may stop timing and determine the waiting time period. In some embodiments, the preset condition may include a plurality of indications indicating that the waiting time period of the user has reached a preset maximum waiting time, a stop waiting instruction from the user, and/or the carpooling order has matched to a driver.

The discount determination unit 620 may also determine the discount based on the waiting time period and a pre-determined corresponding relationship between waiting time periods and discounts. The corresponding relationship between waiting time periods and discounts may include a linear corresponding relationship which indicates that the value of the discount may decrease as the waiting time period is prolonged. In some embodiments, the discount determination unit 620 may determine an original price of the carpooling order based on the starting location and the destination of the carpooling order. The discount determination unit 620 may determine the target price of the carpooling order based on the original price and the discount.

In some embodiments, the discount determination device 600 may further include a condition adjustment unit (not shown in FIG. 6). The condition adjustment unit may be configured to adjust the matching condition of the carpooling order when the information receiving unit 610 receives a stop waiting indication from a user. The matching condition may include an overlapping degree, a proximity degree, a detour degree, etc.

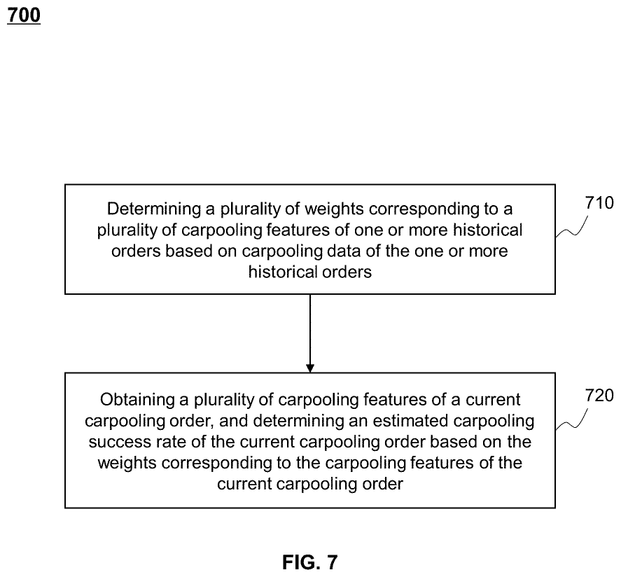

FIG. 7 is a flowchart illustrating an exemplary process 700 for determining an estimated carpooling success rate of a carpooling order according to some embodiments of the present disclosure. In some embodiments, the process 700 may be executed by the processing engine 120. For example, the process 700 may be implemented as a set of instructions (e.g., an application) stored in the storage 160. The server 110, the CPU 220 and/or the CPU 340 may execute the set of instructions and may accordingly be directed to perform the process 700.

In 710, the processing engine 112 may determine a plurality of weights corresponding to a plurality of carpooling features of one or more historical orders based on carpooling data of the one or more historical orders. In some embodiments, the one or more historical orders may be carpooling orders acquired in a predetermined time period (e.g., yesterday, last week, or last month). The carpooling data may refer to order information of the one or more carpooling orders. In some embodiments, carpooling data of a carpooling order may include an order status and a plurality of carpooling features of the carpooling order.

In some embodiments, the order status may further include a success status and a failure status. A succeed carpooling order may correspond to a success status. A failed carpooling order may correspond to a success status. In some embodiments, the processing engine may use a success rate to represent the status of an order. For example, the success status may correspond to a carpooling success rate of 1, and the failure status may correspond to a carpooling success rate of 0.

Carpooling data of a carpooling order may also include a plurality of carpooling features. Merely by ways of example, the plurality of carpooling features may include a distance between a location of a driver and a pick-up location of a passenger, a distance between a destination of a driver and a destination of a passenger, the number of drivers around a passenger, a time difference between an estimated time point when a driver arrives a pick-up location of a passenger and a boarding time of the passenger, etc. The one or more carpooling features may have an effect on whether the carpooling order can be matched to a driver.

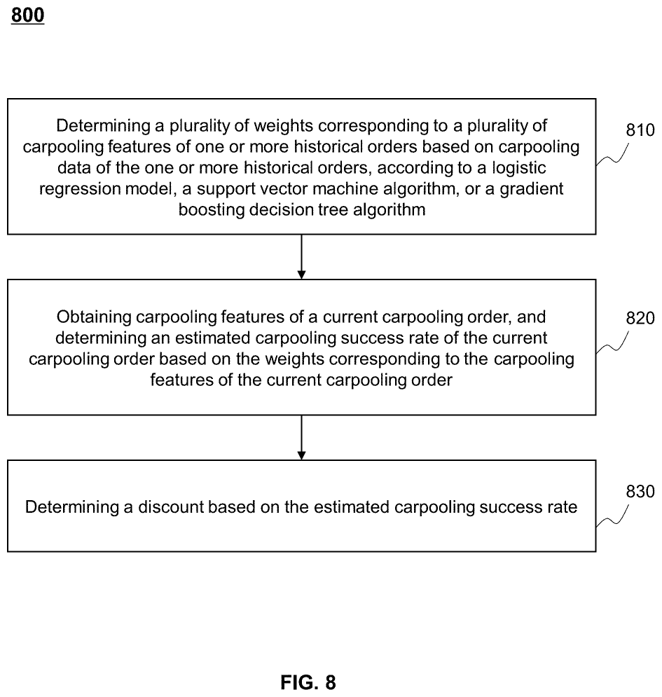

The weight used herein may refer to a coefficient for a carpooling feature, which indicates an influence degree of the carpooling feature on the carpooling success rate. In some embodiments, the processing engine 112 may determine a weight of a carpooling feature based on carpooling success rates and the plurality of carpooling features of the one or more historical orders. In some embodiments, the processing engine 112 may determine the weights according to various algorithms, such as a logistic regression model, a support vector machine algorithm, or a gradient boosting decision tree algorithm. Detailed descriptions regarding the determination of the weight may be disclosed elsewhere in the present disclosure, for example, FIG. 8 and the descriptions thereof.

In some embodiments, 710 may be an offline training phase to determine a weight corresponding to each carpooling feature.

In 720, the processing engine 112 may obtain a plurality of carpooling features of a current carpooling order, and determine an estimated carpooling success rate of the current carpooling order based on a plurality of weights corresponding to the carpooling features of the current carpooling order. In some embodiments, the current carpooling order may have same carpooling features as the historical carpooling orders. In some embodiments, the weight corresponding to a carpooling feature of the current carpooling order may have same value as that of a same carpooling feature of a historical carpooling order. The processing engine 112 may determine an estimated carpooling success rate of a current carpooling order based on the weights corresponding to the carpooling features of the one or more historical carpooling orders.

The estimated carpooling success rate of the current carpooling order may refer to a probability that the current carpooling order can be matched to a driver. Detailed descriptions regarding the determination of the estimated carpooling success rate may be disclosed elsewhere in the present disclosure, for example, FIG. 8 and the descriptions thereof. In some embodiments, the on-demand service system 100 may add and/or delete one or more carpooling features according to actual situations, so as to improve an accuracy of the estimated carpooling success rate.

In some embodiments, 720 may be an online calculation phase, in which the processing engine 112 may determine the estimated carpooling success rate of the current carpooling order based on the carpooling features of the current carpooling order and the weights corresponding to the carpooling features determined in the offline training phase.

The process 700 may further determine a discount of the carpooling order based on the estimated carpooling success rate. The execution of the process 700 may reduce costs of passengers as well as improve incomes of drivers and service providers (e.g., the founders or maintainers of the on-demand service system 100), thus may achieve win-win situation among passengers, drivers and service providers. The process 700 may also contribute to determine a reasonable discount of the current carpooling order.

FIG. 8 is a flowchart illustrating an exemplary process 800 for processing a carpooling order according to some embodiments of the present disclosure. In some embodiments, the process 800 may be executed by the processing engine 120. For example, the process 800 may be implemented as a set of instructions (e.g., an application) stored in the storage 160. The server 110, the CPU 220 and/or the CPU 340 may execute the set of instructions and may accordingly be directed to perform the process 800.

In 810, the processing engine 112 may determine a plurality of weights corresponding to a plurality of carpooling features of one or more historical orders based on carpooling data of the one or more historical orders. The processing engine 112 may determine a weight corresponding a carpooling feature according to various algorithms, such as a logistic regression (LR) model, a support vector machine algorithm, a gradient boosting decision tree algorithm, or the like. Similar to 710 in the process 700, the carpooling data of a historical carpooling order may include an order status (e.g., a success status, a failure status) and carpooling features of the order. In some embodiments, the processing engine 112 may determine a weight according to a logistic regression model. The processing engine 112 may determine the plurality of weights corresponding to the plurality of carpooling features according to Equation (1):

Y=1/(1+exp(W^{T}x)), (1)

where Y may represent the carpooling success rate, the value of Y may be 1 for a success status, and may be 0 for a failure status, x may represent quantization values of the carpooling features, and W may represent the weights corresponding to the carpooling features. In some embodiments, both x and W may be in forms of matrices. In some embodiments, the processing engine 112 may determine the weights W based on a maximum likelihood algorithm.

In the process of determining the weights W, the processing engine 112 may determine values of Y in Equation (1) according to order statuses of the one or more historical orders. More particular, the value of Y may be 1 for a success status, and may be 0 for a failure status. In some embodiments, the processing engine 112 may determine x according to the carpooling features of the one or more historical orders, and then determine the weights W according to Equation (1).

In some embodiments, the carpooling data may include two carpooling features: a distance between a location of a driver and a pick-up location of a passenger, and the number of drivers around a passenger. The processing engine 112 may determine x based on a feature discretization method. If the distance between a location of a driver and a pick-up location of a passenger is a meters and a discrete granularity is b, the distance may be expressed as a/b. In some embodiments, a 1 by n matrix [c₁ . . . cₙ] which includes n elements may represent the distance a. If the value of c₁+a/b does not exceed cₙ, the k-th element of the matrix [c₁ . . . cₙ] may be set to 1 and other elements may be set to 0, where k=INT(c₁+a/b−1), and INT(c₁+a/b−1) may denote the maximum integer that does not exceed c₁+a/b−1; if the value of c₁+a/b exceeds cₙ, the n-th element cₙ may be set to 1 and other elements may be set to 0. In some embodiments, the processing engine 112 may discretize the number of the drivers around the passenger and other carpooling features in a same way as that to determine x.

Merely for illustration purposes, a distance between a location of a driver and a pick-up location of a passenger is 135 meters. The processing engine 112 may use four elements to represent the distance. The discrete granularity may be 50. Since INT(1+135/50−1) equals to 3, the processing engine 112 may determine a distance vector of [0, 0, 1, 0]. The processing engine 112 may use another four elements to represent the number of drivers, and determine a driver number vector in a same way. For example, the processing engine 112 may determine x to be [0, 0, 1, 0, 0, 1, 0, 0].

The processing engine 112 may determine the weights W based on x according to Equation (1) and conventional algorithms such as a maximum likelihood method. For example, the matrix of the weights W may be W=[w1, w2, w3, w4, w5, w6, w7, w8]. In some embodiments, elements w1 through w8 may be positive or negative decimals. Each element may refer to a weight corresponding a carpooling feature.

It should be noted that the determination of the weights is not limited to the LR model described as Equation (1). For example, the processing engine 112 may use a support vector machine algorithm, or a Gradient Boosting Decision Tree (GBDT) algorithm to determine the weights. The GBDT algorithm may be better than the LR model in terms of the accuracy of calculation results, but the GBDT algorithm may be more complicated than the LR model.

Merely for illustration purposes, the processing engine 112 may set the predetermined time period as two weeks. It should be noted that the predetermined time period herein may not be limited to two weeks, and the processing engine 112 may determine a longer or a shorter time period according to practical situations. The processing engine 112 may determine a time period in which the carpooling data includes one or more carpooling features. Due to ever-changing requirements of passengers, the one or more carpooling features may be different under different circumstances. The processing engine 112 may select a proper time period to obtain a certain amount of carpooling data, thus ensuring a calculation efficiency.

In 820, the processing engine 112 may obtain carpooling features of a current carpooling order, and determine an estimated carpooling success rate of the current carpooling order based on the weights corresponding to the carpooling features of the current carpooling order. In some embodiments, the processing engine 112 may determine the estimated carpooling success rate of the current carpooling order according to Equation (2):

Y₁=1/(1+exp(−W₁^{T}x₁)), (2)

where Y₁ may represent an estimated carpooling success rate of the current carpooling order, x₁ may represent a quantization value of carpooling features of the current carpooling order, and W₁ may represent weights corresponding to the carpooling features of the current carpooling order. In some embodiments, the current carpooling order may have same carpooling features as the historical carpooling orders. In some embodiments, the weight corresponding to a carpooling feature of the current carpooling order may have same value as that of a same carpooling feature of a historical carpooling order. In some embodiments, the processing engine 112 may determine x₁ according to a feature discretization method similar to or same as the method described in 810.

In 830, the processing engine 112 may determine a discount based on the estimated carpooling success rate. In some embodiments, the processing engine 112 may determine a discount for a certain estimated carpooling success rate. The processing engine 112 may determine the discount according to actual situations to minimize costs of the passengers as well as improve benefits of drivers and service providers.

In some embodiments, the processing engine 112 may set a lower discount value for a carpooling order with a higher estimated carpooling success rate, and may set a higher discount value for a carpooling order with a lower estimated carpooling success rate. The lower discount value may motivate more passengers to request carpooling services, while the higher discount value may improve benefits of both drivers and service providers. Merely by way of example, the processing engine 112 may set a discount of 50% for a carpooling order with an estimated carpooling success rate of more than 90%, may set a discount of 60% for a carpooling order with an estimated carpooling success rate between 80% and 90%, and may set a discount of 90% for a carpooling order with an estimated carpooling success rate of less than 50%.

The processing engine 112 may determine the weights corresponding to the carpooling features of one or more historical carpooling orders in an offline training phase, and determine an estimated carpooling success rate of a current carpooling order in an online calculation phase. Then the processing engine 112 may determine a reasonable discount for the current carpooling order based on the estimated carpooling success rate. The processing engine 112 may set a lower discount value for carpooling orders with higher estimated carpooling success rates, while may set a higher discount value for carpooling orders with lower estimated carpooling success rates so as to obtain more carpooling orders. This may reduce costs of passengers as well as improve benefits of drivers and service providers.

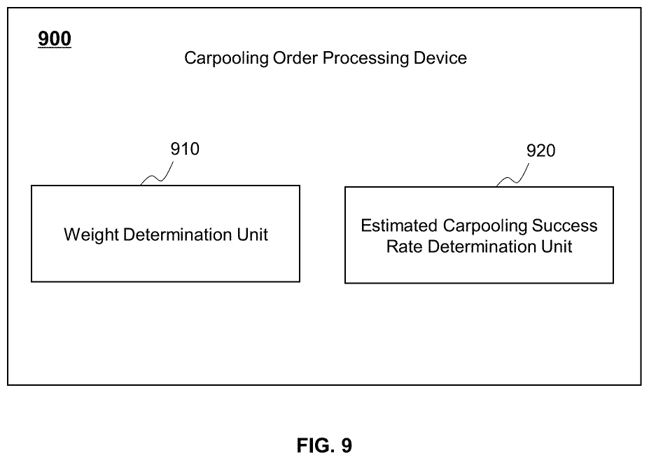

FIG. 9 is a block diagram illustrating an exemplary carpooling order processing device 900 according to some embodiments of the present disclosure. The carpooling order processing device 900 may include a weight determination unit 910 and an estimated carpooling success rate determination unit 920. In some embodiments, the carpooling order processing device 900 may be configured to perform one or more operations of the process 700 and/or the process 800. In some embodiments, the carpooling order processing device 900 may be implemented as the processing device 120.

The weight determination unit 910 may be configured to determine a plurality of weights corresponding to a plurality of carpooling features of one or more historical carpooling orders based on carpooling data of the one or more historical orders. In some embodiments, the one or more historical orders may be carpooling orders. Carpooling data of a carpooling order may include an order status and a plurality of carpooling features of the carpooling order.

The estimated carpooling success rate determination unit 920 may be configured to obtain a plurality of carpooling features of a current carpooling order, and determine an estimated carpooling success rate of the current carpooling order based on a plurality of weights corresponding to the plurality of carpooling features of the current carpooling order.

The carpooling order processing device 900 may determine the estimated carpooling success rate, and may further determine a discount based on the estimated carpooling success rate. The carpooling order processing device 900 may determine the discount according to actual situations to minimize costs of the passengers as well as improve benefits of drivers and service providers.

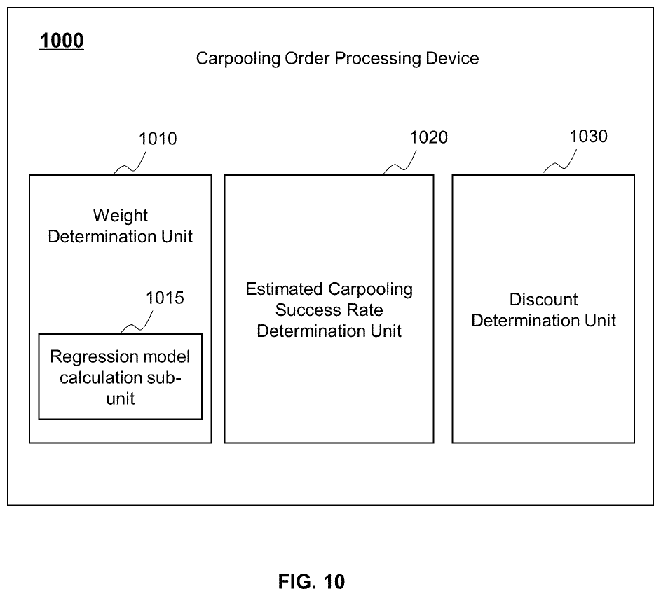

FIG. 10 a block diagram illustrating an exemplary carpooling order processing device 1000 according to some embodiments of the present disclosure. The carpooling order processing device 1000 may include a weight determination unit 1010, an estimated carpooling success rate determination unit 1020, and a discount determination unit 1030. In some embodiments, the carpooling order processing device 1000 may be configured to perform one or more operations in the process 700 and/or the process 800. In some embodiment, the weight determination unit 1010 may perform similar functions as the weight determination unit 910. In some embodiments, the estimated carpooling success rate determination unit 1020 may also perform similar functions as the estimated carpooling success rate determination unit 920. In some embodiments, the carpooling order processing device 1000 may be implemented as the processing device 120.

The weight determination unit 1010 may include a regression model calculation sub-unit 1015. The regression model calculation sub-unit 1015 may be configured to determine a plurality of weights corresponding to a plurality of carpooling features for a carpooling success rate based on a logistic regression (LR) model.

The regression model calculation sub-unit 1015 may determine the weights corresponding to the carpooling features based on an order status and the carpooling features according to Equation (1) as described above.

In some embodiments, the weight determination unit 1010 may determine the weights corresponding to the carpooling features using a support vector machine algorithm, or a Gradient Boosting Decision Tree (GBDT) algorithm.

The estimated carpooling success rate determination unit 1020 may determine an estimated carpooling success rate of a current carpooling order according to Equation (2) as described above.

The discount determination unit 1030 may be configured to determine a discount based on the estimated carpooling success rate determined by the estimated carpooling success rate determination unit 1020.

The carpooling order processing device 1000 may determine an estimated carpooling success rate of the carpooling order based on the weights corresponding to the carpooling features, and then determine a discount of the carpooling order according to the estimated carpooling success rate. The carpooling order processing device 1000 may set lower discounts for carpooling orders with higher estimated carpooling success rates, and may set higher discounts for carpooling orders with lower estimated carpooling success rates. The carpooling order processing device 1000 may reduce costs of passengers as well as improve incomes of drivers and service providers, thus may achieve tripartite wining among passengers, drivers and service providers.

In some embodiments, the process 700, the process 800, the carpooling order processing device 900, and/or the carpooling order processing device 1000 of the present disclosure may determine a plurality of weights corresponding a plurality of carpooling features according to a LR model or other machine learning algorithms in an offline training phase, and determine an estimated carpooling success rate of a current order according to the determined weights and the corresponding carpooling features of the current carpooling order. The process 700, the process 800, the carpooling order processing device 900, and/or the carpooling order processing device 1000 may also set a lower discount for a carpooling order with a higher estimated carpooling success rate, and may set a higher discount for another carpooling order with a lower estimated carpooling success rate. A lower discount may motivate more passengers to request carpooling services, while a higher discount may reduce losses of both drivers and service providers, thus may achieve tripartite winning among passengers, drivers and service providers

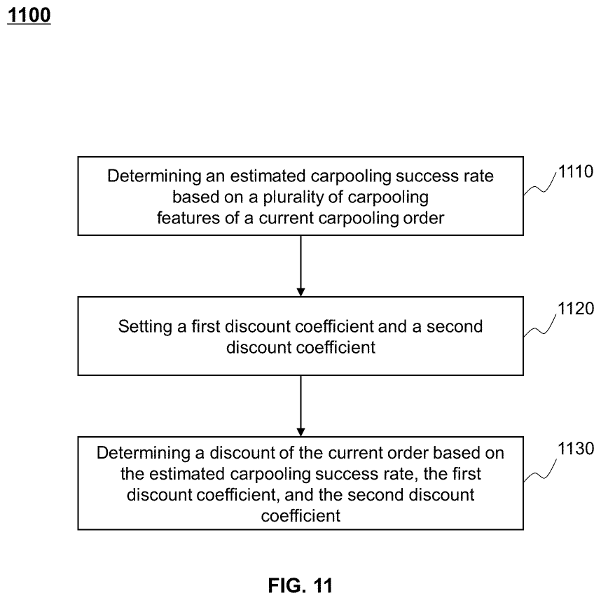

FIG. 11 is a flowchart illustrating an exemplary process 1100 for determining a discount of a carpooling order according to some embodiments of the present disclosure. In some embodiments, the process 1100 may be executed by the processing engine 120.

In 1110, the processing engine 112 may determine an estimated carpooling success rate based on a plurality of carpooling features of a current carpooling order. In some embodiments, the plurality of carpooling features may include, for example, a distance between a location of a driver and a pick-up location of a passenger, a distance between a destination of a driver and a destination of a passenger, the number of drivers around a passenger, a time difference between an estimated time point when a driver arrives a pick-up location of a passenger and a boarding time of the passenger, etc. It should be noted that the processing engine 112 may add and/or delete one or more carpooling features according to actual situations to improve accuracy of the estimated carpooling success rate. The processing engine 112 may determine the estimated carpooling success rate based on the carpooling features of the current order and weights corresponding to the carpooling features. The processing engine 112 may determine the weights by performing 710 in the process 700 and/or 810 in the process 800. In some embodiments, the processing engine 112 may execute 1110 by performing one or more operations in the process 700 and/or the process 800. It should be noted that the determination of the estimated carpooling success rate may not be limited to the method described in the process 700 and/or the process 800. For example, the processing engine 112 may determine the estimated carpooling success rate according to other machine learning algorithms or experiences.

In 1120, the processing engine 112 may set a first discount coefficient and a second discount coefficient. In some embodiments, the first discount coefficient may relate to a success status of a carpooling order, and the second discount coefficient may relate to a failure status of a carpooling order.

The processing engine 112 may set the first discount coefficient and the second discount coefficient according to practical situations. In some embodiments, the first discount coefficient may be smaller than the second discount coefficient. For example, the processing engine 112 may determine a smaller value of 50% as the first discount coefficient, and determine a larger value of 95% as the second discount coefficient. In this way, the on-demand service system 100 may effectively motivate passengers to carpool, ensure a certain amount of carpooling orders, and reduce losses of service providers by setting a higher discount coefficient corresponding to a failure status of a carpooling order.

In 1130, the processing engine 112 may determine a discount of the current order based on the estimated carpooling success rate, the first discount coefficient, and the second discount coefficient. In some embodiments, the processing engine 112 may determine the discount according to Equation (3):

d=a×r+b×(1−r), (3)

where a may represent the first discount coefficient, b may represent the second discount coefficient, r may represent the estimated carpooling success rate, and d may represent the discount.

In some embodiments, given an overall estimated carpooling success rate R of a city, the processing engine 112 may determine discounts of orders in the city according to Equation (4):

D=a×R+b×(1−R), (4)

where a may denote a first discount coefficient, b may denote a second discount coefficient, R may denote the overall estimated carpooling success rate of the city, and D may denote discounts for orders in the city.

For example, an estimated carpooling success rate of Beijing may be 0.4 (i.e., R=0.4). Given a second discount coefficient of 95%, and a first discount coefficient of 55%, the discount of orders in Beijing may be 80%.

If the estimated carpooling success rate has a certain deviation, the value of the discount may not fluctuate drastically. However, the discount may be relatively stable instead. For example, if an actual carpooling success rate of an order is x1, an estimated carpooling success rate of the order is x2, the processing engine 112 may determine the deviation for the estimated carpooling success rate according to Equation (5):

delta=x1−x2, (5)

where delta may denote the deviation for the estimated carpooling success rate.

Then the processing engine 112 may determine the deviation for the discount according to Equation (6):

d1=d2=(a×x1+b×(1−x1))−(a×x2+b×(1−x2)), (6)

where d1−d2 may denote the deviation for the discount.

If a is 0.65 and b is 0.95, the deviation may be 0.1, and the fluctuation of the deviation for the discount may be 0.03. In spite of a deviation for the estimated carpooling success rate, the discount value may be relatively accurate and stable. The method for determining a discount of a carpooling order described in the process 1100 may not require manual configuration, thus may save manpower as well as achieve tripartite winning among passengers, drivers and service providers (e.g., founders or maintainers of the on-demand service system 100).

In some embodiments, the processing engine 112 may adjust the first discount coefficient and the second discount coefficient according to the discount of the current order and the estimated carpooling success rate. For example, the processing engine 112 may adjust the parameters a and/or b according to various situations in practice. The processing engine 112 may determine the parameters a and/or b based on the discount d and the estimated carpooling success rate r in accordance with Equation (3). For example, if the estimated carpooling success rate r is 0.6, and the processing engine 112 may set the value of d to 70%, the first discount coefficient a may be 90% or 80%, and the second discount coefficient b may be 40% or 55%, respectively.

The processing engine 112 may set a first discount coefficient a for a success status and a second discount coefficient b for a failure status, and then determine a discount d based on an estimated carpooling success rate r, the first discount coefficient a, and the second discount coefficient b. In some embodiments, the processing engine 112 may adjust the first discount coefficient a and/or the second discount coefficient b based on practical situations. The method for determining a discount of a carpooling order described in the process 1100 may not require manual configuration, which saves manpower as well as achieves tripartite win among passengers, drivers and service providers (e.g., founders or maintainers of the on-demand service system 100). In some embodiments, at least one step of 1110 through 1130 in the process 1100 may be merged into other steps.

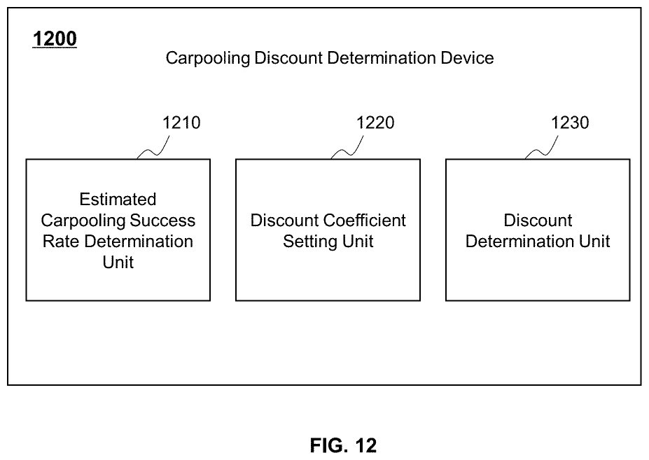

FIG. 12 is a block diagram illustrating an exemplary carpooling discount determination device 1200 according to some embodiments of the present disclosure. The carpooling discount determination device 1200 may include an estimated carpooling success rate determination unit 1210, a discount coefficient setting unit 1220, and a discount determination unit 1230. In some embodiments, the carpooling discount determination device 1200 may be configured to perform one or more operations in the process 1100. In some embodiments, the carpooling discount determination device 1200 may be implemented as the processing device 120.

The estimated carpooling success rate determination unit 1210 may be configured to determine an estimated carpooling success rate based on carpooling features of a current order. In some embodiments, the estimated carpooling success rate determination unit 1210 may further include a weight determination sub-unit and an estimated carpooling success rate determination sub-unit (not shown in FIG. 12).

The weight determination sub-unit may be configured to determine a plurality of weights corresponding to a plurality of carpooling features of one or more historical carpooling orders based on carpooling data of the one or more historical carpooling orders. Carpooling data of a carpooling order may include an order status and a plurality of carpooling features of the carpooling order. The order status may include a success status and a failure status.

The estimated carpooling success rate sub-unit may be configured to obtain carpooling features of the current order, and determine the estimated carpooling success rate of the current order based on a plurality of weights corresponding to the carpooling features of the current order.

The discount coefficient setting unit 1220 may be configured to set a first discount coefficient and a second discount coefficient. In some embodiments, the first discount coefficient may related to a success status of a carpooling order, and the second discount coefficient may related to a failure status of a carpooling order.

The discount determination unit 1230 may be configured to determine a discount of the current order based on the estimated carpooling success rate, the first discount coefficient, and the second discount coefficient. In some embodiments, the discount determination unit 1230 may determine the discount according to Equation (3). In some embodiments, the carpooling discount determination device 1200 may also include a discount adjusting unit. The discount adjusting unit may be configured to adjust the first discount coefficient and/or the second discount coefficient based on the discount determined by the discount determination unit 1230 and the estimated carpooling success rate of the current order determined by the estimated carpooling success rate determination unit 1210.

The discount determination device 1200 may determine the discount based on the estimated carpooling success rate, the first discount coefficient and the second discount coefficient. In spite of a deviation for the estimated carpooling success rate, the discount may be relatively stable. The carpooling discount determination device 1200 may execute a method for determining a discount of a carpooling order that may not require manual configuration, which saves manpower as well as achieves tripartite win among passengers, drivers and service providers (e.g., founders or maintainers of the on-demand service system 100).

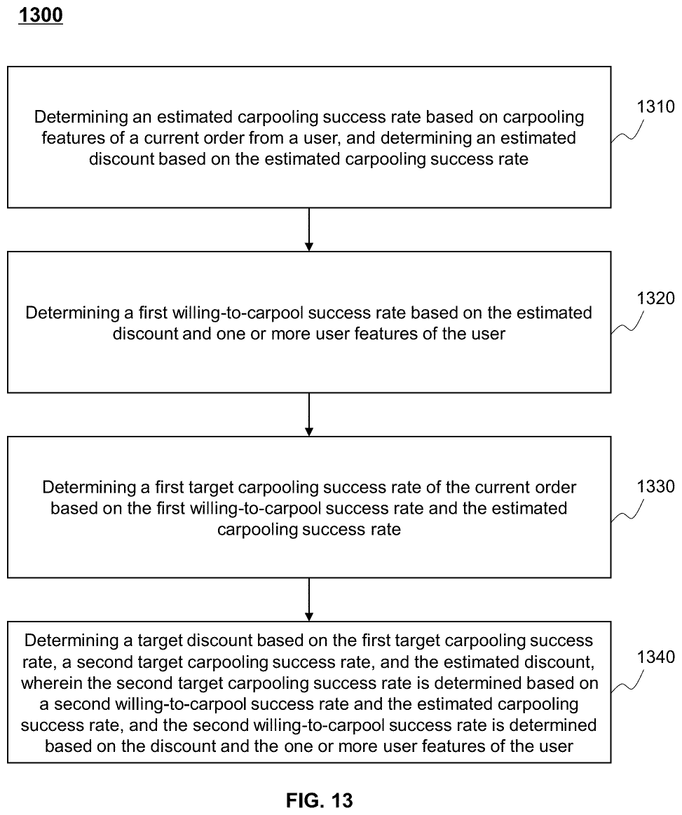

FIG. 13 is a flowchart illustrating an exemplary process 1300 for determining a discount of a carpooling order according to some embodiments of the present disclosure. In some embodiments, the process 1300 may be executed by the processing engine 112. For example, the process 1300 may be implemented as a set of instructions (e.g., an application) stored in the storage 160. The server 110, the CPU 220 and/or the CPU 340 may execute the set of instructions and may accordingly be directed to perform the process 1300.

In 1310, the processing engine 112 may determine an estimated carpooling success rate based on a plurality of carpooling features of a current order from a user, and determine an estimated discount based on the estimated carpooling success rate. The carpooling features may include a distance between a location of a driver and a pick-up location of a passenger, a distance between a destination of a driver and a destination of a passenger, the number of drivers around a passenger, a time difference between an estimated time point when a driver arrives at a pick-up location of a passenger and a boarding time of the passenger, etc. It should be noted that the processing engine 112 may add and/or delete one or more carpooling features according to actual situations to dynamically improve the accuracy of the estimated carpooling success rate. The processing engine 112 may determine the estimated carpooling success rate based on the plurality of carpooling features of the current order and a plurality of weights corresponding to the carpooling features. In some embodiments, each carpooling feature of the carpooling order may correspond to a weight. The processing engine 112 may determine the plurality of weights by performing 710 in the process 700 and/or 810 in the process 800. In some embodiments, the processing engine 112 may execute 1310 in the process 1300 by performing one or more operations in the process 700 and/or the process 800. It should be noted that the determination of the estimated carpooling success rate may not be limited to the process 700 and/or the process 800. For example, the processing engine 112 may determine the estimated carpooling success rate according to other machine learning algorithms or experiences.

The estimated discount may refer to a predetermined discount, which may be set by a user, or determined by the on-demand service system 100. In some embodiments, a user may set an estimated discount corresponding to an estimated carpooling success rate according to practical experiences (e.g., via the mobile device 300). Merely by way of example, a user may determine a first estimated discount value of 80% corresponding to a first estimated carpooling success rate between 0.7 and 0.8. A user may determine a second estimated discount of 90% corresponding to a second estimated carpooling success rate between 0.8 and 0.9. A user may determine a third estimated discount of 95% corresponding to a third estimated carpooling success rate between 0.9 and 0.95. In some embodiments, the processing engine 112 may retrieve an estimated discount corresponding to the determined estimated carpooling success rate from a storage device disclosed in the present disclosure capable of storing data (e.g., the storage 160, or the storage 390). In some embodiments, the processing engine 112 may determine the estimated discount based on a correlation between estimated discounts and estimated carpooling success rates. The correlation may include a positive correlation, an inverse correlation, a linear correlation, a square correlation, etc.

In order to motivate more passengers to request carpooling services and ensure a certain success rate of the carpooling services, the processing engine 112 may set a higher discount for orders with a higher estimated carpooling success rate, and may set a lower discount for orders with a lower estimated carpooling success rate. In some embodiments, the estimated discount may have a positive correlation to the estimated carpooling success rate. For example, the estimated discount may be higher as the estimated carpooling success rate increases. Merely for illustration purposes, the estimated discount corresponding to an estimated carpooling success rate of 0.74 may be 80%; the estimated discount corresponding to an estimated carpooling success rate of 0.85 may be 90%; and the estimated discount corresponding to an estimated carpooling success rate of 0.95 may be 95%.

In 1320, the processing engine 112 may determine a first willing-to-carpool success rate based on the estimated discount and one or more user features of the user. The processing engine 112 may acquire one or more user features from historical orders of the user. The user features may include the user's attitude towards carpooling, the frequency of calling an on-demand service, and other information related to the historical orders, such as order prices, starting locations, destinations, etc. In some embodiments, the user features may also include information about whether the user is a first-time user. A first-time user may refer to a user that calls for a carpooling service for a first time. A user who is not a first-time user may also be referred to as a “non-first-time user”.

The processing engine 112 may determine the first willing-to-carpool success rate according to Equation (7):

p_{will}(e)=f(e, user features), (7)

where p_{will}(e) may denote the first willing-to-carpool success rate, and e may denote the estimated discount. In some embodiments, Equation (7) may be a function in which the estimated discount and the user features may be variables.

In 1330, the processing engine 112 may determine a first target carpooling success rate of the current order based on the first willing-to-carpool success rate and the estimated carpooling success rate. In some embodiments, the first target carpooling success rate may be an arithmetic product of the first willing-to-carpool success rate and the estimated carpooling success rate. The processing engine 112 may determine the first target carpooling success rate according to Equation (8):

p(e)=p_{will}(e)×pₑₛ, (8)

where e may represent the estimated discount, p(e) may represent the first target carpooling success rate, p_{will}(e) may represent the first willing-to-carpool success rate, and pₑₛ may represent the estimated carpooling success rate.

In 1340, the processing engine 112 may determine a target discount based on the first target carpooling success rate, a second target carpooling success rate, and the estimated discount. As used herein, the target discount may have the same meaning as the discount. In some embodiments, the processing engine 112 may determine the second target carpooling success rate based on a second willing-to-carpool success rate and the estimated carpooling success rate. In some embodiments, the processing engine 112 may determine the second willing-to-carpool success rate based on the discount and the user features. In some embodiments, the processing engine 112 may determine the second willing-to-carpool success rate according to Equation (9):

p_{will}(e′)=f(e′, user features), (9)

where p_{will}(e′) may denote the second willing-to-carpool success rate, and e′ may denote the target discount. In some embodiments, Equation (9) may be a function in which both the discount and the user features are variables.

The processing engine 112 may determine the second target carpooling success rate according to the following Equation (10):

p(e′)=p_{will}(e′)×pₑₛ (10)

where e′ may represent the target discount, p(e′) may represent the second target carpooling success rate, p_{will}(e′) may represent the second willing-to-carpool success rate and pₑₛ may represent the estimated carpooling success rate.

For a non-first-time user, the processing engine 112 may determine, according to Equation (10), a maximum value of the discount, which corresponds to a minimum decrease amount of the second target carpooling success rate. In another word, the processing engine 112 may determine a proper discount so as to ensure a higher discount as well as a lower decrease amount of the second target carpooling success rate. For a first-time user, the processing engine 112 may determine, according to Equation (10), a maximum value of the second target carpooling success rate, which corresponds to a minimum increase amount of the estimated discount.

In some embodiments, the processing engine 112 may provide a higher discount for users who may complete carpooling orders, and provide a lower discount for users who failed. Merely for illustration purposes, taking one or more user features into account, a non-first-time user may not be sensitive to the price of an order. The on-demand service system 100 may determine an estimated discount of 60%. However, given a discount of 60% or 80%, the values of p_{will}(e) for the non-first-time user may be almost the same. For the non-first-time user, the discount may not be a key factor, and the user may prefer to carpool with others. In this way, it is better to give a discount of 80% to save costs of drivers without effecting the carpooling success rate, and increase benefits of service providers as well. Therefore, in the process of determining a willing-to-carpool success rate (e.g., the first willing-to-carpool success rate, the second willing-to-carpool success rate) based on user features, the processing engine 112 may take one or more user features of the current order into the determination of the target discount. The processing engine 112 may determine the discount according to user features, which ensures a higher carpooling success rate as well as achieve tripartite wins among users, drivers and service providers.

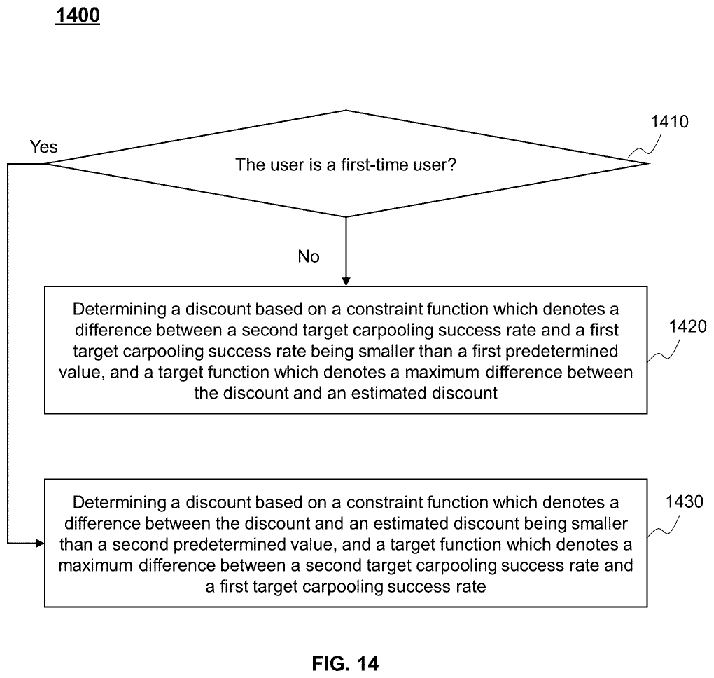

FIG. 14 is a flowchart illustrating exemplary process 1400 for determining a discount of a carpooling order according to some embodiments of the present disclosure. In some embodiments, the process 1400 may be executed by the processing engine 112. For example, the process 1400 may be implemented as a set of instructions (e.g., an application) stored in the storage 160. The server 110, the CPU 220 and/or the CPU 340 may execute the set of instructions and may accordingly be directed to perform the process 1400.

In 1410, the processing engine 112 may determine whether a user is a first-time user. If the user is a first-time user, the process 1400 may proceed to 1430. If the user is not a first-time user (also referred to as a “non-first-time user”), the process 1400 may proceed to 1420.

In 1420, the processing engine 112 may determine a discount based on a constraint function which denotes a difference between a second target carpooling success rate and a first target carpooling success rate being no larger than a first predetermined value, and a target function which denotes a maximum difference between the discount and an estimated discount.

The processing engine 112 may determine a discount which satisfies a predetermined condition. In some embodiments, the predetermined condition may include a difference between the second target carpooling success rate and the first target carpooling success rate, which is not larger than a predetermined value. In some embodiments, the processing engine 112 may determine the discount according to Functions (11) and (12):

delta(p)=p(e′)−p(e)≤C, (11)

f₁=max(delta(e)), delta(e)=e′−e, (12)

where p(e′) may represent the second target carpooling success rate, p(e) may represent the first target carpooling success rate, and C may represent a first predetermined value. In some embodiments, C may be a negative number. And e′ may represent the discount, e may represent the estimated discount, and f₁ may represent a first target function. In some embodiments, the processing engine 112 may determine a range of the discount e′ according to Function (11), and then select a value of e′ within the range. The value of e′ may lead to a maximum difference between the value of the estimated discount and the value of the discount.

The processing engine 112 may determine the discount of an order of a non-first-time user according to Functions (11) and (12). The processing engine 112 may ensure a certain amount of carpooling orders as well as increase discounts of the carpooling orders. For example, the processing engine 112 may delimit the decrease amount of carpooling orders in a range of 0.01% by setting the value of C to be −0.01%.

In 1430, the processing engine 112 may determine a discount based on a constraint function which denotes a difference between the discount and an estimated discount being no larger than a second predetermined value, and a target function which denotes a maximum difference between a second target carpooling success rate and a first target carpooling success rate.

In 1430, the processing engine 112 may determine a discount which satisfies a predetermined condition. In some embodiments, the predetermined condition may include a difference between the discount and the estimated discount, which is not larger than a predetermined value. In some embodiments, the processing engine 112 may determine the discount according to Functions (13) and (14):

delta(e)=e′−e≤D, (13)

f₂=max (p(e′)−p(e)), (14)

where e′ may represent the discount, e may represent the estimated discount, and D may represent a second predetermined value. In some embodiments, D may be a negative number. p(e′) may represent the second target carpooling success rate, p(e) may represent the first target carpooling success rate, and f₂ may represent a second target function. In some embodiments, the processing engine 112 may determine a range of the discount e′ according to Function (13), and then may determine a value of e′ within the range. The value of e′ may lead to a maximum difference between the second target carpooling success rate and the first target carpooling success rate.

The processing engine 112 may determine the discount of an order of a first-time user according to Functions (13) and (14). The processing engine 112 may ensure a certain discount of carpooling orders as well as increase amount of the carpooling orders. For example, the processing engine 112 may delimit the decrease amount of the discount in a range of 0.1 by setting the value of D to be −0.1. In other words, if the estimated discount is 80%, the discount is no more than 70%.

In some embodiments, the process 1400 may further include a step for acquiring one or more user features of a user. The processing engine 112 may perform operations in 1410 for determining whether the user is a first-time user based on the acquired user features.

In some embodiments, the processing engine 112 may adjust the first predetermined value (i.e., the parameter C in Function (11)) and/or the second predetermined value (i.e., the parameter D in Function (13)) at any time based on the user features, requirements of user and/or benefits of service providers.

The process 1300 and the process 1400 may take user features of a user into the determination of the discount of the order in the present disclosure. The processing engine 112 may determine a more reasonable discount based on the estimated carpooling success rate, the user features (e.g., a first-time user or a non-first-time user).

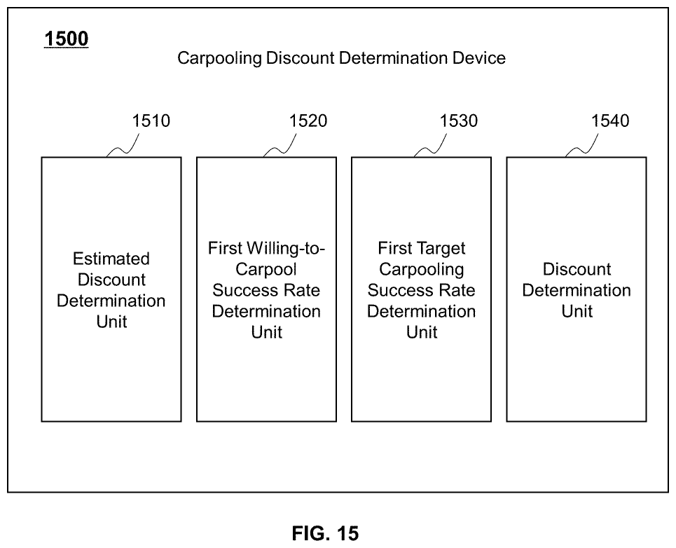

FIG. 15 is a block diagram illustrating an exemplary carpooling discount determination device 1500 according to some embodiments of the present disclosure. The carpooling discount determination device 1500 may include an estimated discount determination unit 1510, a first willing-to-carpool success rate determination unit 1520, a first target carpooling success rate determination unit 1530, and a discount determination unit 1540. In some embodiments, the carpooling discount determination device 1500 may be configured to perform one or more operations in the process 1300 and/or the process 1400. In some embodiments, the carpooling discount determination device 1500 may be implemented as the processing device 120.

The estimated discount determination unit 1510 may be configured to determine an estimated carpooling success rate based on carpooling features of a current order from a user and determine an estimated discount based on the estimated carpooling success rate.

The first willing-to-carpool success rate determination unit 1520 may be configured to determine a first willing-to-carpool success rate based on the estimated discount and user features of the user. The first willing-to-carpool success rate determination unit 1520 may determine the first willing-to-carpool success rate, for example, according to Equation (7).

The first target carpooling success rate determination unit 1530 may be configured to determine a first target carpooling success rate of the current order based on the first willing-to-carpool success rate and the estimated carpooling success rate. The first target carpooling success rate determination unit 1530 may determine the first target carpooling success rate according to, for example, Equation (8).

The discount determination unit 1540 may be configured to determine a discount based on the first target carpooling success rate, a second target carpooling success rate and the estimated discount. The discount determination unit 1540 may determine the second target carpooling success rate based on a second willing-to-carpool success rate and the estimated discount. The discount determination unit 1540 may determine the second willing-to-carpool success rate based on the discount and the user features. The discount determination unit 1540 may determine the second willing-to-carpool success rate according to, for example, Equation (9). The discount determination unit 1540 may determine the second target carpooling success rate according to, for example, Equation (10). For a non-first-time user, the discount determination unit 1540 may determine, according to Equation (10), a maximum value of the discount, which corresponds to a minimum decrease amount of the second target carpooling success rate. For a first-time user, the discount determination unit 1540 may determine, according to Equation (10), a maximum value of the second target carpooling success rate, which corresponds to a minimum increase amount of the estimated discount.

The carpooling discount determination device 1500 may determine a willing-to-carpool success rate (e.g., the first willing-to-carpool success rate, the second willing-to-carpool success rate) based on the one or more user features. The carpooling discount determination device 1500 may take the one or more user features of the current order into the determination of the discount. The carpooling discount determination device 1500 may determine the discount according to user features, which ensures a higher carpooling success rate as well as achieve tripartite winning among users, drivers and service providers.

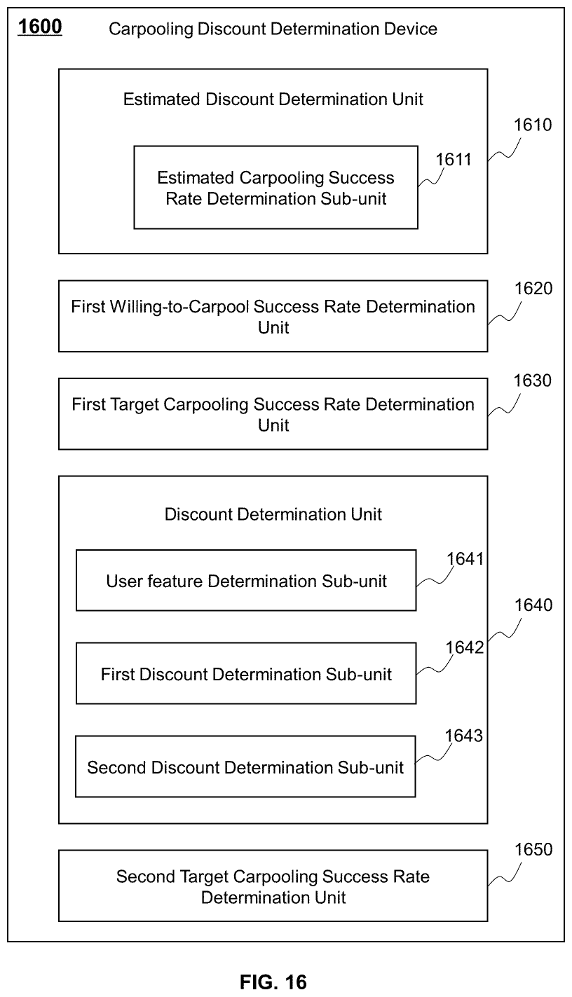

FIG. 16 is a block diagram illustrating an exemplary carpooling discount determination device 1600 according to some embodiments of the present disclosure. The carpooling discount determination device 1600 may include an estimated discount determination unit 1610, a first willing-to-carpool success rate determination unit 1620, a first target carpooling success rate determination unit 1630, a discount determination unit 1640, and a second target carpooling success rate determination unit 1650. In some embodiments, the carpooling discount determination device 1600 may be configured to perform one or more operations in the process 1300 and/or the process 1400. In some embodiments, the carpooling discount determination device 1600 may be implemented as the processing device 120.

The estimated discount determination unit 1610 may further include an estimated carpooling success rate determination sub-unit 1611. The estimated carpooling success rate determination sub-unit 1611 may be configured to determine a plurality of weights corresponding to a plurality of carpooling features for one or more historical orders based on carpooling data of the one or more historical orders. In some embodiments, the on-demand service system 100 may acquire the one or more historical orders in a predetermined time period (e.g., last two weeks). The estimated carpooling success rate determination sub-unit 1611 may also obtain carpooling features of a current order, and determine an estimated carpooling success rate of the current order based on the weights corresponding to carpooling features of the current order. In some embodiments, the carpooling data of a current order may include at least one carpooling feature of the carpooling features of the historical orders.

The first willing-to-carpool success rate determination unit 1620 may be configured to determine a first willing-to-carpool success rate based on the estimated discount and user features of a user.

The first target carpooling success rate determination unit 1630 may be configured to determine a first target carpooling success rate of the current order based on the first willing-to-carpool success rate and the estimated carpooling success rate.

The discount determination unit 1640 may determine a discount based on the first target carpooling success rate, a second target carpooling success rate, and the estimated discount.

As illustrated in FIG. 16, the discount determination unit 1640 may further include a user feature determination sub-unit 1641, a first discount determination sub-unit 1642, and a second discount determination sub-unit 1643.

The user feature determination sub-unit 1641 may be configured to determine whether a user is a first-time user or a non-first-time user. For a non-first-time user, the first discount determination sub-unit 1642 may be configured to determine a discount based on a constraint function which denotes a difference between a second target carpooling success rate and a first target carpooling success rate being smaller than a first predetermined value, and a target function which denotes a maximum difference between the discount and an estimated discount. The user feature determination sub-unit 1641 may determine a discount which satisfies a predetermined condition. In some embodiments, the predetermined condition may include a difference between the second target carpooling success rate and the first target carpooling success rate, which is not larger than a predetermined value. In some embodiments, the user feature determination sub-unit 1641 may determine the discount according to Functions (11) and (12).

For a first-time user, the second discount determination sub-unit 1643 may be configured to determine a discount based on a constraint function which denotes a difference between the discount and an estimated discount being smaller than a second predetermined value, and a target function which denotes a maximum difference between a second target carpooling success rate and a first target carpooling success rate. The second discount determination sub-unit 1643 may determine a discount which satisfies a predetermined condition. In some embodiments, the predetermined condition may include a difference between the discount and the estimated discount, which is not larger than a predetermined value. In some embodiments, the second discount determination sub-unit 1643 may determine the discount according to Functions (13) and (14).

The second target carpooling success rate determination unit 1650 may be configured to determine the second target carpooling success rate, for example, according to Equation (10). The process 1300, the process 1400, the carpooling discount determination device 1500 and/or the carpooling discount determination device 1600 may be applied to not only determine the estimated carpooling success rate of an order, but also determine the willing-to-carpool success rate (e.g., the first willing-to-carpool success rate, the second willing-to-carpool success rate) of a user. The willing-to-carpool success rate may relate to the estimated discount and user features of the user (e.g., whether the user is sensitive to price). The process 1300, the process 1400, the carpooling discount determination device 1500 and/or the carpooling discount determination device 1600 may also determine a target carpooling success rate (e.g., the first target carpooling success rate, the second target carpooling success rate) based on the estimated carpooling success rate of the order, and the willing-to-carpool success rate of the user. The process 1300, the process 1400, the carpooling discount determination device 1500 and/or the carpooling discount determination device 1600 may further determine an appropriate discount based on the estimated carpooling success rate of the order, the estimated discount, and the target carpooling success rate of the order.

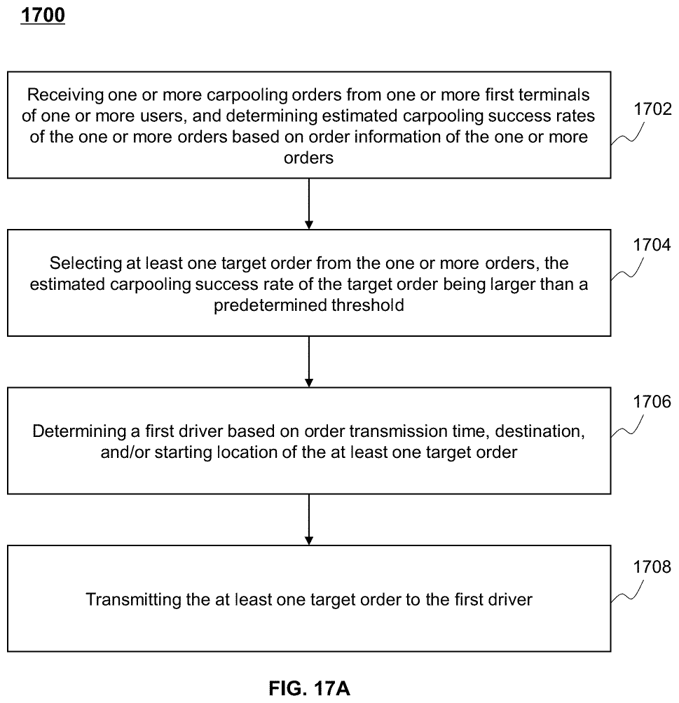

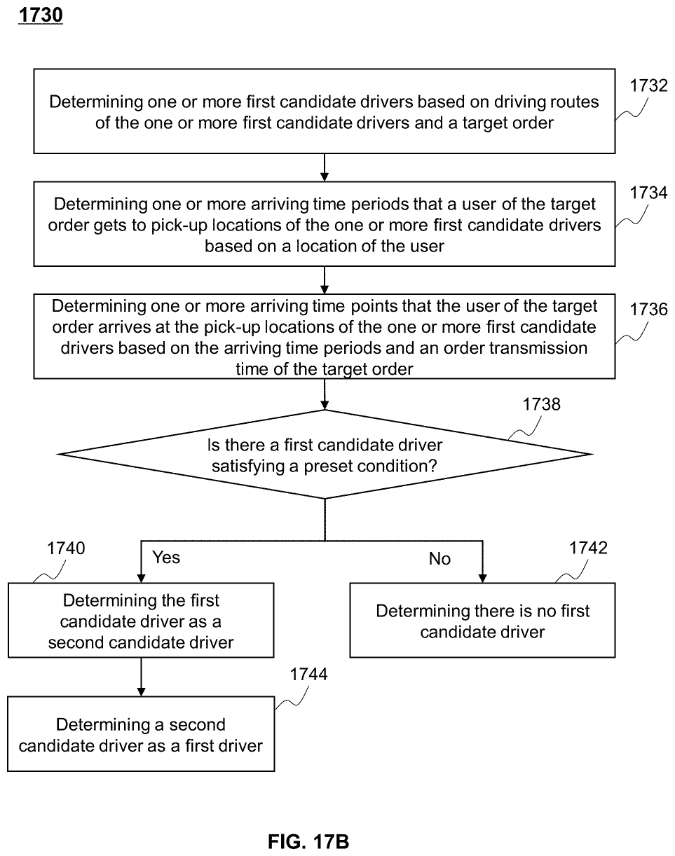

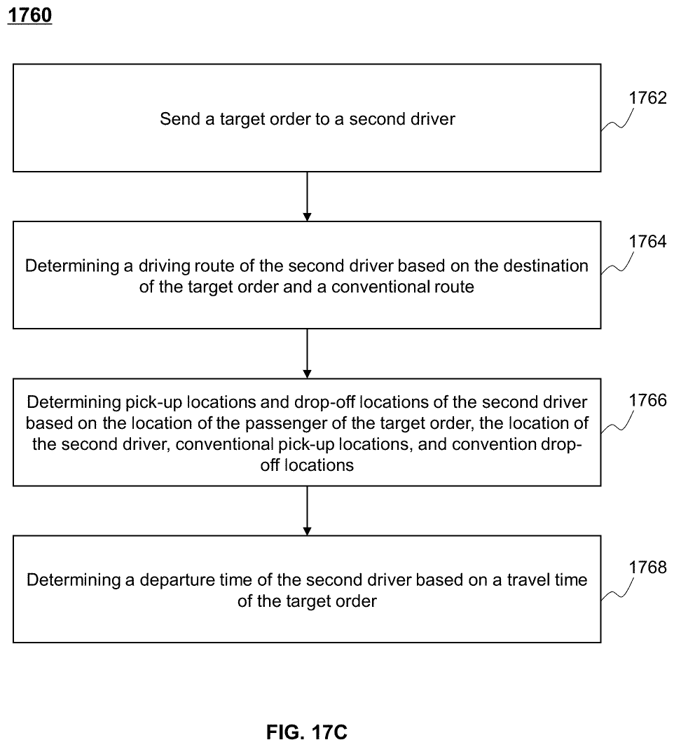

FIG. 17A is a flowchart illustrating an exemplary process 1700 for determining a first driver according to some embodiments of the present disclosure. In some embodiments, the process 1700 may be executed by the processing engine 112. For example, the process 1700 may be implemented as a set of instructions (e.g., an application) stored in the storage 160. The server 110, the CPU 220 and/or the CPU 340 may execute the set of instructions and may accordingly be directed to perform the process 1700.

In 1702, the processing engine 112 may receive one or more carpooling orders from one or more users, and determine estimated carpooling success rates of the one or more carpooling orders based on order information of the one or more carpooling orders. The processing engine 112 may receive the one or more carpooling orders from first terminals of one or more users. In some embodiments, the one or more orders may be carpooling orders or vanpooling orders. The carpooling order or a vanpooling order may refer to an order that a user is willing to share at least part of the target transportation service with another passenger. In some embodiments, the one or more orders may be current orders. The processing engine 112 may receive the current orders from first terminals of one or more users. The first terminal may include, for example, the terminal device 130, the mobile device 300, or the like. In some embodiments, the processing engine 112 may acquire order information of the one or more orders, such as carpooling features, order transmission time, destination, starting location, boarding time, or the like, or a combination thereof. In some embodiments, the processing engine 112 may determine an estimated carpooling success rate for each of the one or more carpooling orders based on carpooling features of each carpooling order and weights corresponding to the carpooling features. In some embodiments, the processing engine 112 may determine the weights and/or the estimated carpooling success rate of each carpooling order by performing 710 in the process 700 and/or 810 in the process 800. In some embodiments, the processing engine 112 may determine the estimated carpooling success rate of each carpooling order based on machine learning algorithms or experiences.

In 1704, the processing engine 112 may select a target order from the one or more carpooling orders. In some embodiments, the estimated carpooling success rate of the target order may be larger than a predetermined threshold. The on-demand service system 100 may determine the predetermined threshold according to default setting. The processing engine 112 may select at least one target order from the one or more carpooling orders, and send the selected target order(s) to certain users (e.g., certain numbers of drivers). In some embodiments, the processing engine 112 may control the amount of carpooling orders or vanpooling orders as well as ensure the benefits of users and drivers by filtering target orders from carpooling orders or vanpooling orders.

In 1706, the processing engine 112 may determine a first driver based on order transmission time, destination, and/or starting location of the at least one target order. In some embodiment, the first driver may be a driver of a public vehicle (e.g., a minibus, a light bus, etc.). The processing engine 112 may acquire information of the first driver, such as a driving route, a plurality of pick-up locations and drop-off locations, and a departure time. In some embodiment, the processing engine 112 may determine the driving route, pick-up locations, drop-off locations and departure time of a first driver based on an order. Detailed description of determination of the first driver may be disclosed elsewhere in the present disclosure, for example, FIG. 17B and the descriptions thereof.

In 1708, the processing engine 112 may transmit the target order to the first driver. In some embodiments, the processing engine 112 may transmit the target order to a second terminal of the first driver. The second terminal may include, for example, the driver device 140, the mobile device 300, or the like.

The processing engine 112 may further transmit information of the first driver (e.g., pick-up locations, etc.) to the user of the target order.

It should be noted that the above-mentioned public vehicle may include a small vehicle (e.g., a minibus, which is capable of carrying about 9 to 24 people), or a large vehicle (e.g., a shuttle bus or a public aircraft, which is capable of carrying more than 24 people). The processing engine 112 may determine a first driver of a certain type of public vehicle according to the target order and/or actual situation.

In the process 1700, the processing engine 112 may select target orders with estimated carpooling success rates higher than the threshold from the one or more order. The processing engine 112 may acquire one or more driving parameters (e.g., the driving route) of a plurality of first drivers, and select a first driver matched to the target order according to carpooling features of the target order. During this process, the on-demand service system 100 may achieve dynamic assignments of vehicles according to actual orders, thus may effectively improve carpooling efficiency and flexibility as well as guarantee benefits of both users and drivers.

FIG. 17B is a flowchart illustrating an exemplary process 1730 for determining a first driver according to some embodiments of the present disclosure. In some embodiments, the process 1730 may be executed by the processing engine 112.

In 1732, the processing engine 112 may determine one or more first candidate drivers based on driving routes of the one or more first candidate drivers and a target order. The processing engine 112 may determine distances between the destination of the target order and at least one location on driving routes of the one or more first drivers. In some embodiments, the processing engine 112 may determine one or more first candidate drivers based on the distances. More particular, for each first driver, the processing engine 112 may determine whether the distance between the destination of the target order and at least one location on the driving route of the first driver is in a predetermined distance range. If the distance is in the predetermined distance range, the processing engine 112 may determine the first driver as a first candidate driver. The on-demand service system 100 may determine the predetermined distance range according to actual situations. In some embodiments, the on-demand service system 100 may determine the predetermined distance range based on big data analysis or user experiences. In some embodiments, the driving routes of the one or more first candidate drivers may pass through the destination of the target order.

In 1734, the processing engine 112 may determine one or more arriving time periods that the passenger of the target order gets to pick-up locations of the one or more first candidate drivers based on the location of the passenger. For each of the one or more first candidate drivers, the processing engine 112 may determine an arriving time period that the passenger gets to the pick-up location of each of the one or more first candidate drivers.

In 1736, the processing engine 112 may determine one or more arriving time points at which the passenger of the target order arrives at the pick-up locations of the one or more first candidate drivers based on the arriving time periods and an order transmission time of the target order. For each first candidate driver, the processing engine 112 may determine an arriving time point at which the passenger of the target order arrives at the pick-up location of the first candidate driver. In some embodiments, the processing engine 112 may determine the arriving time point based on the arriving time period and the order transmission time.

In 1738, the processing engine 112 may determine whether a first candidate driver satisfies a preset condition. In some embodiments, the preset condition may be a departure time of a first candidate driver being later than the arriving time point at which the passenger gets to a pick-up location of the first candidate driver. If there is no first candidate driver satisfies the preset condition, the process 1730 may proceed to 1742 to determine a second driver for the passenger of the target order based on the location of the passenger. Detailed descriptions regarding the second driver may be disclosed in FIG. 17C and the descriptions thereof. If there is a first candidate driver satisfies the preset condition, the process 1730 may proceed to 1740, and the processing engine 112 may determine the first candidate driver as a second candidate driver.

In 1740, the processing engine 112 may determine the first candidate driver satisfying the preset condition as a second candidate driver.

In 1744, the processing engine 112 may determine a second candidate driver as a first driver. If there is one second candidate driver, the processing engine 112 may determine the second candidate driver as a first driver. If there are more than one second candidate drivers, the processing engine 112 may select a second candidate driver as a first driver. In some embodiments, the processing engine 112 may randomly select a second candidate driver as a first driver. In some embodiments, the processing engine 112 may select a second candidate driver as a first driver based on condition that a pick-up location of the second candidate driver is closest to the location of the passenger.

FIG. 17C is a flowchart illustrating an exemplary process 1760 for determining a second driver according to some embodiments of the present disclosure. In some embodiments, the process 1760 may be executed by the processing engine 112.

In 1762, the processing engine 112 may send a target order to a second driver. In some embodiment, the second driver may be a driver of a public vehicle (e.g., a minibus, a light bus, etc.). In some embodiments, the second driver may not be matched to an order. In another word, the driving route, pick-up locations, drop-off locations, and departure time of the second driver may be undetermined until the processing engine 112 receives the target order. In some embodiments, the processing engine 112 may determine a second driver based on the location of the passenger of the target order. For example, the processing engine 112 may select a driver whose location is closest to the location of the passenger of the target order from the plurality of drivers as the second driver.

In 1764, the processing engine 112 may determine a driving route of the second driver based on the destination of the target order and a conventional route. The conventional route may refer to a route that most drivers or passengers choose. In some embodiments, the processing engine 112 may determine convention routes based on historical data.

In 1766, the processing engine 112 may determine pick-up locations and drop-off locations of the second driver based on the location of the passenger of the target order, the location of the second driver, conventional pick-up locations, and conventional drop-off locations. The conventional pick-up locations and conventional drop-off locations may refer to locations close to hot spots, such as a school, a hospital, a supermarket, a scenic spot, or the like. In some embodiments, the processing engine 112 may determine the convention pick-up locations and the convention drop-off locations based on historical data relate to pick-up locations and drop-off locations, or based on map data. The processing engine 112 may determine a plurality of pick-up locations and drop-off locations along the driving route. In some embodiments, the processing engine 112 may select one or more pick-up locations and drop-off locations from the plurality of pick-up locations and drop-off locations to guarantee a certain amount of carpooling orders.

In 1768, the processing engine 112 may determine a departure time of the second driver based on a boarding time of the passenger of the target order. The processing engine 112 may determine the departure time of the second driver by adding a time margin based on the boarding time of the passenger of the target order. For example, if the boarding time of the passenger of the target order is at 9:00 a.m., the processing engine 112 may determine a departure time of 9:10 a.m. for the second driver. In some embodiments, the processing engine 112 may determine the time margin based on practical experiences or default settings.

The processing engine 112 may further transmit the pick-up locations, drop-off locations, driving route and/or departure time of the second driver to the passenger of the target order and the second driver. The processing engine 112 may inform the second driver and the user to reach a pick-up location on time.

The process 1760 may provide a method for assigning an idle driver (i.e., the second driver) for the target order in the absence of a first driver. In some embodiments, the processing engine 112 may execute the process 1760 after a second driver has received the target order.

In the process 1760, the processing engine 112 may dynamically adjust one or more driving parameters (such as a driving route, a departure time, etc.) of a second driver based on order information of the target order (the destination, the location of the passenger, etc.), thus improving the flexibility, efficiency and success rate of the carpooling process.

In some embodiment, the second driver in the process 1760 may refer to a driver of a public vehicle without a regular driving route, a regular departure time, regular pick-up locations, and regular drop-off locations. In some embodiments, in the process 1760, the processing engine 112 may determine a driving route, pick-up locations, drop-off locations and a departure time of a second driver based on a destination, a location, a boarding time of a passenger of a target order. Comparing with public vehicles with regular driving routes, a public vehicle driven by a second driver may have a higher flexibility and a stronger adaptability. In the process 1760, the processing engine 112 may develop a plurality of hot routes in real time, as well as guarantee benefits of passengers and drivers by determining second drivers of public vehicles.

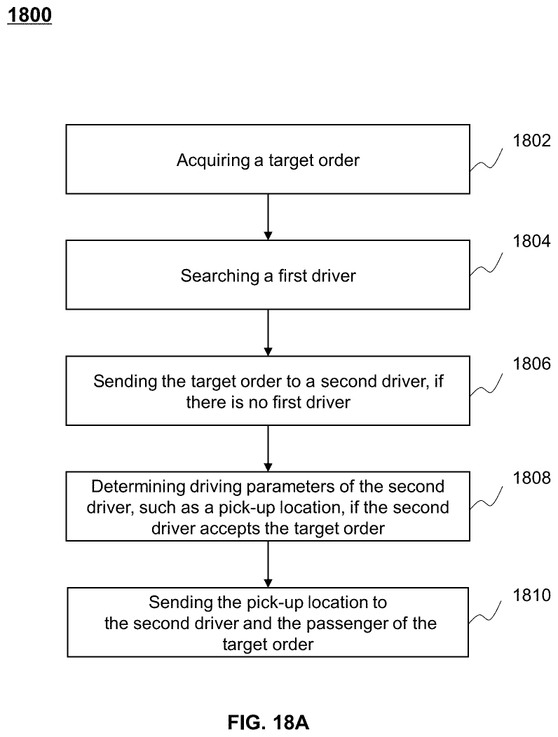

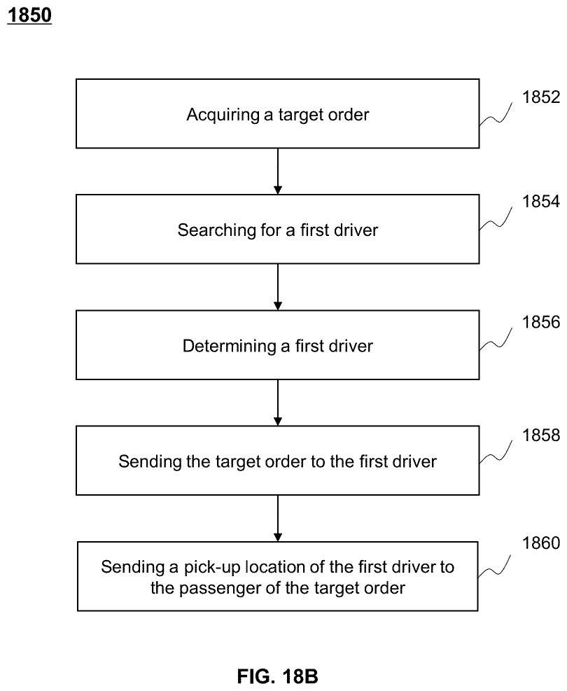

FIG. 18A is a flowchart illustrating an exemplary process 1800 for determining a driver for a target order according to some embodiments of the present disclosure. In some embodiments, the process 1800 may be executed by the processing engine 112.

In 1802, the processing engine 112 may acquire a target order. In some embodiments, the processing engine 112 may execute 1802 by performing operations of 1702 and/or 1704 in the process 1700.

In 1804, the processing engine 112 may search for a first driver. The first driver may be a driver a public vehicle. The first driver may have predetermined driving parameters, such as a driving route, pick-up locations, drop-off locations and a departure time. The processing engine 112 may execute 1804 by performing one or more operations in the process 1730.

In 1806, the processing engine 112 may assign the target order to a second driver, if there is no first driver. The second driver may also be a driver of a public vehicle. In some embodiments, the processing engine 112 may select a driver who is closest to the location of the passenger of the target order from a plurality of drivers around the passenger as the second driver. The processing engine 112 may determine the driving route, pick-up locations, drop-off locations, and departure time of the second driver based on the target order.

In 1808, the processing engine 112 may determine driving parameters of the second driver such as a pick-up location, if the second driver accepts the target order. The driving parameters may include the driving route, pick-up locations, drop-off locations and departure time of the second driver. The processing engine 112 may execute 1808 by performing one or more operations in the process 1760.

In 1810, the processing engine 112 may send the pick-up location to the second driver and the passenger of the target order. The processing engine 112 may send the driving parameters of the second driver to the terminals of the passenger and the second driver.

FIG. 18B is a flowchart illustrating an exemplary process 1850 for determining a driver for a target order according to some embodiments of the present disclosure. In some embodiments, the process 1850 may be executed by the processing engine 112.

In 1852, the processing engine 112 may acquire a target order. In some embodiments, the processing engine 112 may execute 1852 by performing operations of 1702 and/or 1704 in the process 1700.

In 1854, the processing engine 112 may search for a first driver. The first driver may be a driver a public vehicle. The first driver may have predetermined driving parameters, such as a driving route, pick-up locations, drop-off locations and a departure time. The processing engine 112 may execute 1854 by performing one or more operations in the process 1730.

In 1856, the processing engine 112 may determine the first driver.

In 1858, the processing engine 112 may send the target order to the first driver.

In 1860, the processing engine 112 may send a pick-up location of the first driver to the passenger of the target order. The processing engine 112 may transmit information such as the driving route, pick-up locations, drop-off locations and departure time of the first driver to the passenger of the target order. The passenger may need to arrive a pick-up location before the first driver leaves.

The process 1850 may determine a first driver with predetermined driving route and departure time, and assign a target order to the first driver. In the process 1850, the first driver may not need to perform order-receive operations. The passenger related to the target order may need to arrive a pick-up location of the first driver before the first driver leaves. Thus the process 1850 may simplify operations in a carpooling process.

In the process 1700, the process 1730, the process 1760, the process 1900, and/or the process 1950, the processing engine 120 may determine a carpooling order which corresponds to an estimated carpooling success rate higher than a threshold as a target order. The processing engine 120 may assign the target order to a first driver with predetermined driving route, departure time and other driving parameters. If there is no suitable first driver, the processing engine 120 may assign the target order to a second driver without predetermined driving route and other driving parameters. The processing engine 120 may determine the driving route, pick-up locations, drop-off locations and departure time based on the target order. This may guarantee benefits of both users and drivers, as well as achieve dynamic determination of a driving route and assignment of a vehicle according to the target order. Comparing with public vehicles with regular driving routes, a public vehicle driven by a second driver may have a higher flexibility and a stronger adaptability. The processing engine 112 may also develop a plurality of hot routes in real time.

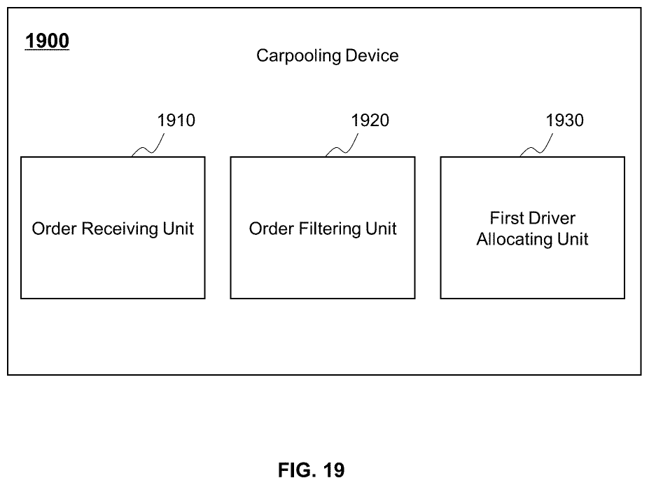

FIG. 19 is a block diagram illustrating an exemplary carpooling device 1800 according to some embodiments of the present disclosure. The carpooling device 1900 may include an order receiving unit 1910, an order filtering unit 1920, and a first driver allocating unit 1930. In some embodiments, the carpooling device 1900 may be configured to perform one or more operations in the process 1700, the process 1730, the process 1760, the process 1800, and/or the process 1850. In some embodiments, the carpooling device 1900 may be implemented as the processing device 120.

The order receiving unit 1910 may be configured to receive one or more historical carpooling orders and at least one current carpooling order from one or more users, and determine estimated carpooling success rates of the one or more carpooling orders. In some embodiments, the order receiving unit 1910 may receive the one or more historical carpooling orders and the current carpooling order via first terminals of the one or more users.

In some embodiments, the order receiving unit 1910 may further include a weight determination and storage sub-unit and an estimated carpooling success rate sub-unit (not shown in FIG. 19). The weight determination and storage sub-unit may determine and store a weight corresponding to each of one or more carpooling features of the one or more historical carpooling orders based on the carpooling data of the one or more historical carpooling orders. In some embodiments, the historical carpooling orders may be acquired in a predetermined time period (e.g., last month). The carpooling data of an order may include an order status and one or more carpooling features of the historical carpooling order.

The estimated carpooling success rate determination sub-unit may obtain carpooling features of a current carpooling order, and determine an estimated carpooling success rate of the current carpooling order. In some embodiments, the current carpooling order may have same carpooling features as the historical carpooling orders. In some embodiments, a weight corresponding to a carpooling feature of the current carpooling order may have same value as the same carpooling feature of a historical carpooling order. The estimated carpooling success rate determination sub-unit may determine an estimated carpooling success rate based on weights corresponding to each carpooling features of the current carpooling order.

The order filtering unit 1920 may be configured to select a target order from the at least one current carpooling order. The estimated carpooling success rate of the target order may be larger than a predetermined threshold.

The first driver allocating unit 1930 may be configured to determine a first driver based on order information of the target order (e.g., an order transmission time, a destination, and/or a location of a passenger of the target order), and transmit the target order to a first driver. The first driver may be a driver of a public vehicle. The first driver may have certain driving parameters, such as a driving route, a departure time, pick-up locations, and drop-off locations. In some embodiments, the first driver allocating unit 1930 may include a first candidate driver determination sub-unit, a second candidate driver determination sub-unit, a first driver determination sub-unit, and a first informing sub-unit (not shown in FIG. 19).

The first candidate driver determination sub-unit may be configured to determine one or more first candidate drivers based on driving routes of the one or more first candidate drivers and the target order. For each first driver, the first candidate driver determination sub-unit may determine whether a distance between the destination of the target order and at least one location on the driving route of the first driver is in a predetermined distance range. If the distance is in the predetermined distance range, the first candidate driver determination sub-unit may determine the first driver as a first candidate driver.

The second candidate driver determination sub-unit may determine a second candidate driver based on arriving time periods that the passenger gets to pick-up locations of the one or more first candidate drivers. For each first candidate driver, the second candidate driver determination sub-unit may determine an arriving time point when the user of the target order arrives at a nearest pick-up location of the first candidate driver. The second candidate driver determination sub-unit may determine whether at least one arriving time point that is before a departure time of a first candidate driver. If there is at least one such first candidate driver, the second candidate driver determination sub-unit may determine the first candidate driver as a second candidate driver.

The first driver determination sub-unit may be configured to determine the number of second candidate drivers. If the number of the second candidate drivers is 1, the first driver determination sub-unit may determine the second candidate driver as a first driver. If the number of the second candidate drivers is larger than 1, the first driver determination sub-unit may determine a first driver by selecting a second candidate driver from the one or more second candidate drivers. A pick-up location of the second candidate driver may be closest to the location of the passenger.

The first informing sub-unit may transmit driving parameters of the first driver, such as the driving route, pick-up locations, drop-off locations and/or a departure time to the passenger of the target order.

In some embodiments, the carpooling device 1800 may further include a second driver allocating unit (not shown in FIG. 19). The second driver allocating unit may assign a second driver for the target order based on the location of the passenger, if there is no suitable first driver. The second driver allocating unit may also determine a driving route, a departure time, pick-up locations, and/or drop-off locations of the second driver based on the destination, the location and/or a boarding time of the passenger of the target order. The second driver allocating unit may further include a second driver determination sub-unit, a driving route determination sub-unit, a pick-up location and drop-off location determination unit, a departure time determination sub-unit and a second informing sub-unit.

The second driver determination sub-unit may determine a second driver. In some embodiments, the second driver determination sub-unit may determine a driver who is closest to the location of passenger of the target order as the second driver. The second driver determination sub-unit may assign the target order to the second driver.

The driving route determination sub-unit may be configured to determine a driving route of the second driver based on the destination of the target order and a conventional route.

The pick-up location and drop-off location determination unit may be configured to determine pick-up locations and drop-off locations of the second driver based on the location of the passenger of the target order, the location of the second driver, conventional pick-up locations, and/or convention drop-off locations.

The departure time determination sub-unit may be configured to determine a departure time of the second driver based on the boarding time of the passenger of the target order.

The second informing sub-unit may be configured to transmit the pick-up locations, drop-off locations, driving route and/or departure time of the second driver to the passenger of the target order and the second driver.

The carpooling device 1900 may guarantee benefits of both users and drivers, and may achieve dynamic assignments of vehicles according to carpooling orders. The carpooling device 1900 may further develop hot routes in real time, and effectively improve the carpooling efficiency and flexibility.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system, comprising:
at least one storage medium including a set of instructions; and
at least one processor in communication with the at least one storage medium, wherein when executing the set of instructions, the at least one processor is directed to:
receive an order from a passenger for a target transportation service from a terminal device;
wherein the order includes a starting location and a destination of the target transportation service and the order is a carpooling order to share at least part of the target transportation service with another passenger;
determine a waiting time period related to the order;
determine a discount based on the waiting time period;
determine a target price of the order based on the starting location, the destination, and the discount;
send the target price to the terminal device;
obtain driving routes of a plurality of drivers;
determine a first matching condition related to the starting location, the destination of the target transportation service, and the driving routes;
determine a target driver from the plurality of drivers based on the first matching condition; and
send the order to the target driver.

2. (canceled)

3. (canceled)

4. The system of claim 1, wherein the first matching condition includes at least one of a first overlapping degree, a first proximity degree, or a first detour degree.

5. The system of claim 1, wherein to determine the waiting time period related to the order, the at least one processor is directed to:
receive a discount determination indication related to the order;
receive a first time point when receiving the order, and a second time point when receiving the discount determination indication; and
determine the waiting time period based on the first time point and the second time point.

6. The system of claim 5, wherein the discount determination indication includes at least one of a stop waiting indication, a time over indication, or an order matching indication.

7. The system of claim 6, wherein the at least one processor is further directed to:
determine whether the discount determination indication includes a time over indication or a stop waiting indication;
in response to the determination that the discount determination indication includes a time over indication or a stop waiting indication,
determine the target driver based on a second matching condition, wherein the second matching condition includes at least one of a second overlapping degree, a second proximity degree, or a second detour degree.

8. The system of claim 1, wherein to determine the discount of the order based on the waiting time period, the at least one processor is directed to:
receive a corresponding relationship between waiting time periods and discounts; and
determine the discount based on the corresponding relationship between waiting time periods and discounts.

9. The system of claim 8, wherein the corresponding relationship between waiting time periods and discounts includes a linear relationship.

10. The system of claim 1, wherein to determine the target price of the order based on the starting location, the destination, and the discount, the at least one processor is directed to:
determine an original price for the target transportation service based on the starting location and the destination; and
determine the target price of the order based on the original price and the discount.

11-30. (canceled)

31. A method implemented on at least one computing device each of which has at least one processor and storage for carpooling, the method comprising:
receiving an order from a passenger for a target transportation service from a terminal device,
wherein the order includes a starting location and a destination of the target transportation service and the order is a carpooling order to share at least part of the target transportation service with another passenger;
determining a waiting time period related to the order;
determining a discount based on the waiting time period;
determining a target price of the order based on the starting location, the destination, and the discount;
sending the target price to the terminal device;
obtaining driving routes of a plurality of drivers;
determining a first matching condition related to the starting location, the destination of the target transportation service, and the driving routes;
determining a target driver from the plurality of drivers based on the first matching condition; and
sending the order to the target driver.

32. (canceled)

33. (canceled)

34. The method of claim 31, wherein the first matching condition includes at least one of a first overlapping degree, a first proximity degree, or a first detour degree;

35. The method of claim 31, wherein the determining the waiting time period related to the order includes:
receiving a discount determination indication related to the order;
receiving a first time point when receiving the order, and a second time point when receiving the discount determination indication; and
determining the waiting time period based on the first time point and the second time point.

36. The method of claim 35, wherein the discount determination indication includes at least one of a stop waiting indication, a time over indication, or an order matching indication.

37. The method of claim 36, further including:
determining whether the discount determination indication includes a time over indication or a stop waiting indication;
in response to the determination that the discount determination indication includes a time over indication or a stop waiting indication,
determining the target driver based on a second matching condition,
wherein the second matching condition includes at least one of a second overlapping degree, a second proximity degree, or a second detour degree.

38. The method of claim 31, wherein the determining the discount of the order based on the waiting time period includes:
receiving a corresponding relationship between waiting time periods and discounts; and
determining the discount based on the corresponding relationship between waiting time periods and discounts.

39. The method of claim 38, wherein the corresponding relationship between waiting time periods and discounts includes a linear relationship.

40-60. (canceled)

61. A non-transitory computer readable medium, comprising a set of instructions, wherein when executed by at least one processor, the set of instructions direct the at least one processor to perform acts of:
receiving an order from a passenger for a target transportation service from a terminal device;
wherein the order includes a starting location and a destination of the target transportation service and the order is a carpooling order to share at least part of the target transportation service with another passenger;
determining a waiting time period related to the order;
determining a discount based on the waiting time period;
determining a target price of the order based on the starting location, the destination, and the discount;
sending the target price to the terminal device;
obtaining driving routes of a plurality of drivers;
determining a first matching condition related to the starting location, the destination of the target transportation service, and the driving routes;
determining a target driver from the plurality of drivers based on the first matching condition; and
sending the order to the target driver.

62. (canceled)
